(19) United States
(12) Patent Application Publication
(10) Pub. No.: US 2016/0239929 A1
(43) Pub. Date: Aug. 18, 2016

(54) SYSTEMS AND METHODS FOR ALLOCATION OF DEVICE RESOURCES USING MULTI-CHARACTER ALPHANUMERIC CODES

(71) Applicant: d.light design, Inc., San Francisco, CA (US)

(72) Inventors: Michael Hudson, Portland, OR (US); Ned Tozun, San Francisco, CA (US)

(21) Appl. No.: 15/041,859

(22) Filed: Feb. 11, 2016

Related U.S. Application Data
(63) Continuation of application No. PCT/US2016/017478, filed on Feb. 11, 2016.
(60) Provisional application No. 62/116,273, filed on Feb. 13, 2015.

(51) Int. Cl. G06Q 50/06; G06Q 30/06

(52) U.S. Cl. CPC G06Q 50/06; G06Q 30/0645

(57) ABSTRACT

A system configurable at least between powered and unpowered states is provided. The system comprises a human interface device for receiving a multi-character alphanumeric code, one or more processors, memory storing programs executed by the processors, and a private key associated with the system. The one or more programs comprise instructions for evaluating usage of the system against a usage threshold. When usage of the system is within the usage threshold, the one or more processors permit the system to be in the powered state. When usage of the system exceeds the usage threshold, the one or more processors force the system to the unpowered state. Responsive to a determination that a received multi-character alphanumeric code is valid, the usage threshold is adjusted by an amount specified by the received code.

### CROSS REFERENCE TO RELATED APPLICATION

This application claims priority to U.S. Provisional Patent Application No. 62/116,273, entitled “Systems and Methods for Allocation of Appliance Resources Using Tokens,” filed Feb. 13, 2015, which is hereby incorporated by reference.

This application also claims priority to International Patent Application No. PCT/US2016/017478, entitled “Systems and Methods for Allocation of Device Resources Using Multi-Character Alphanumeric Codes,” filed Feb. 11, 2016, which is hereby incorporated by reference.

### TECHNICAL FIELD

This specification describes technologies relating to destination device control and more specifically to destination device usage restriction.

One in four people worldwide lack electricity. In many developing nations, centralized electrical production is not available and acquiring autonomous electrical production capabilities and appliances for utilizing produced electricity is cost prohibitive. The upfront costs of purchasing solar energy cells and related hardware as well as basic appliances such as lights, refrigerators, and fans is just too great for many people. Thus, a need exists for systems and methods that enable budget constrained households to have reliable sources of electrical power. This would greatly improve health and quality of life while, at the same time, ensure that providers of those systems are properly compensated.

In response to this tremendous need, a number of pay-as-you-go and related systems have been implemented. In a typical embodiment, such systems obtain codes through cellular networks. Such codes either allow users that do not own electrical equipment, or are in the process of buying such equipment on an installment plan, to use the electrical equipment for a limited period of time defined by the codes received through such networks. A substantial drawback with such systems is that for product at the desired price point that will make such devices accessible to those household in need of such devices, the cellular network costs for such devices, in addition to the ongoing and recurring SIM card fee to keep the cellular connection alive in such devices, represents a substantial percentage of the total device unit cost.

The above identified technical problems are reduced or eliminated by the systems and methods disclosed herein.

### SUMMARY

Technical solutions (e.g., computing systems, methods, and non-transitory computer readable storage mediums) for appliance control and more specifically to destination device usage restriction are provided. Such usage restrictions allow for the distribution of advanced solar power generation devices to households that cannot afford to buy such devices, without risk of loss of such devices. Advantageously, there is no requirement that such devices have a SIM card or wireless connectivity, thereby driving down production costs and allowing for better penetration in lower income regions. In fact, to reduce costs, in typical embodiments such devices do not have a SIM card or cellular connectivity, thereby driving down production costs and allowing for better penetration in lower income regions.

The following presents a summary of the present disclosure in order to provide a basic understanding of some of the aspects of the present disclosure. This summary is not an extensive overview of the present disclosure. It is not intended to identify key/critical elements of the invention or to delineate the scope of the invention. Its sole purpose is to present some of the concepts of the present disclosure in a simplified form as a prelude to the more detailed description that is presented later.

Various embodiments of systems, methods and devices within the scope of the appended claims each have several aspects, no single one of which is solely responsible for the desirable attributes described herein. Without limiting the scope of the appended claims, some prominent features are described herein. After considering this discussion, and particularly after reading the section entitled “Detailed Description” one will understand how the features of various embodiments are used.

An aspect of the present disclosure is directed to a system configurable at least between a powered state and an unpowered state. The system comprises a human interface device (e.g., keypad) configured to receive a first multi-character alphanumeric code, one or more processors, and memory storing one or more programs to be executed by the one or more processors. The one or more programs comprise a decryption module, and a private key associated with the system. The private key is stored in at least a non-volatile portion of the memory. The system further comprises one or more data structures that store a plurality of multi-character alphanumeric codes that have previously been entered into the human interface device and that have been determined by the decryption module to be valid. The one or more programs comprise instructions for evaluating usage of the system against a usage threshold. When usage of the system is within the usage threshold, the one or more processors permit the system to be in the powered state and when usage of the system exceeds the usage threshold, the one or more processors force the system to the unpowered state. Responsive to a determination by the decryption module that the first multi-character alphanumeric code is valid, the usage threshold is adjusted by an amount specified by the first multi-character alphanumeric code.

The decryption module determines that the first multi-character alphanumeric code is valid by evaluating the first multi-character alphanumeric code against each respective multi-character alphanumeric code in the plurality of multi-character alphanumeric codes in the one or more data structures. The first multi-character alphanumeric code is deemed to be invalid when an exact match is found. The first multi-character alphanumeric code is decrypted in accordance with the private key thereby forming a decrypted multi-character alphanumeric code. A first checksum of at least a portion of the decrypted multi-character alphanumeric code is calculated. This first checksum is compared to a second checksum. The second checksum is obtained from a first predetermined portion of the decrypted multi-character alphanumeric code. The first multi-character alphanumeric code is deemed to be invalid when the first checksum and the second checksum do not match each other. The first multi-character alphanumeric code is deemed to be valid when it has not been determined to be invalid by the foregoing evaluating or the comparing.

Another aspect of the present disclosure is directed to a non-transitory computer readable storage medium storing one or more programs configured for execution by one or more processors. The one or more programs comprising instructions for evaluating usage of a system against a usage threshold. When usage of the system is within the usage threshold, the one or more processors permit the system to be in a powered state and when usage of the system exceeds the usage threshold, the one or more processors force the system to an unpowered state. Responsive to a determination by a decryption module that a first multi-character alphanumeric code is valid, the usage threshold is adjusted by an amount specified by the first multi-character alphanumeric code.

The decryption module determines that the first multi-character alphanumeric code is valid by evaluating the first multi-character alphanumeric code against each respective multi-character alphanumeric code in a plurality of multi-character alphanumeric codes, where the first multi-character alphanumeric code is deemed to be invalid when an exact match is found between the first multi-character alphanumeric code and a multi-character alphanumeric code in the plurality of multi-character alphanumeric codes. The first multi-character alphanumeric code is decrypted in accordance with a private key uniquely associated with the system thereby forming a decrypted multi-character alphanumeric code. A first checksum of at least a portion of the decrypted multi-character alphanumeric code is calculated and compared to a second checksum. The second checksum is obtained from a first predetermined portion of the decrypted multi-character alphanumeric code. The first multi-character alphanumeric code is deemed to be invalid when the first checksum and the second checksum do not match each other. The first multi-character alphanumeric code is deemed to be valid when it has not been determined to be invalid by the foregoing evaluating or the comparing.

Another aspect of the present disclosure provides a server comprising one or more processors, a plurality of data elements, where each respective data element in the plurality of data elements is for a corresponding system in a plurality of systems, and where each respective data element in the plurality of data elements comprises a unique identifier, a unique serial number, and a private key that are each uniquely associated with the corresponding system. The server further comprises memory storing one or more programs to be executed by the one or more processors. The one or more programs comprise instructions for receiving a registration request for a first system in the plurality of systems from a first origination. The registration request includes a serial number and a mobile station international subscriber directory number (MSISDN) for an entity in possession of the first system. The first system is not addressable by the MSISDN and the registration request is associated with rate information for the first system. The MSISDN and rate information for the first system is stored in the data element associated with the first system when the serial number in the registration request matches the serial number in the data element. A payment message is received from a second origination. The payment message comprises an MSISDN number, a unique identifier, and an amount paid. The unique identifier is used to identify a second system in the plurality of systems, whereupon identification of the second system, the one or more programs further comprise instructions for constructing a multi-character alphanumeric code by forming a candidate multi-character alphanumeric code where a first portion of the candidate multi-character alphanumeric code identifies a service type associated with the payment message, a second portion of the candidate multi-character alphanumeric code identifies an amount of the service type in accordance with the payment message, a third portion of the candidate multi-character alphanumeric code is randomly generated, and a fourth portion of the candidate multi-character alphanumeric code is a checksum computed using (i) at least a predetermined portion of the multi-character alphanumeric code and (ii) the private key that is uniquely associated with the second system. The candidate multi-character alphanumeric code is evaluated for uniqueness against a plurality of test multi-character alphanumeric codes that have been previously sent to the second system. The he forming and evaluating are repeated until the candidate multi-character alphanumeric code does not match any multi-character alphanumeric code in the plurality of test multi-character alphanumeric codes. The candidate multi-character alphanumeric code is communicated to an MSISDN number associated with the second system thereby enabling a user associated with the second system to maintain the second system in a usable state.

Still another aspect of the present disclosure provides a non-transitory computer readable storage medium storing one or more programs configured for execution by one or more processors. The one or more programs comprising instructions for receiving a registration request for a first system in a plurality of systems from a first origination. The registration request includes a serial number and a mobile station international subscriber directory number (MSISDN) for an entity in possession of the first system. The first system is not addressable by the MSISDN and the registration request is associated with rate information for the first system. The MSISDN and rate information for the first system is stored in the data element associated with the first system when the serial number in the registration request matches the serial number in the data element. A payment message is received from a second origination. The payment message comprises an MSISDN number, a unique identifier, and an amount paid. The unique identifier is used to identify a second system in the plurality of systems. Upon identification of the second system, the one or more programs further comprise instructions for constructing a multi-character alphanumeric code by forming a candidate multi-character alphanumeric code where a first portion of the candidate multi-character alphanumeric code identifies a service type associated with the payment message, a second portion of the candidate multi-character alphanumeric code identifies an amount of the service type in accordance with the payment message, a third portion of the candidate multi-character alphanumeric code is randomly generated, and a fourth portion of the candidate multi-character alphanumeric code is a checksum computed using (i) at least a predetermined portion of the multi-character alphanumeric code and (ii) the private key that is uniquely associated with the second system. The candidate multi-character alphanumeric code is evaluated for uniqueness against a plurality of test multi-character alphanumeric codes that have been previously sent to the second system. The forming and evaluating are repeated until the candidate multi-character alphanumeric code does not match any multi-character alphanumeric code in the plurality of test multi-character alphanumeric codes. The candidate multi-character alphanumeric code is communicated to an MSISDN number associated with the second system thereby enabling a user associated with the second system to maintain the second system in a usable state.

Another aspect of the present disclosure provides an electronic device that hosts one or more services. Each service in the one or more services is configurable between an active state and at least one inactive state. In some embodiments, there is a single program and the active state is a powered state. In some embodiments, there is a single program and the active state is a powered state and the at least one inactive state is a single non-powered state. The electronic device comprises a human interface device configured to receive a first multi-character alphanumeric code, one or more processors, and a memory storing one or more programs to be executed by the one or more processors. A non-volatile portion of the memory stores a first private key associated with the electronic device and a first unit identifier that uniquely identifies the electronic device from among a plurality of electronic devices. The memory further stores a first counter. The one or more programs comprise instructions for evaluating usage of each respective service in the one or more services against a corresponding usage threshold. In other words, each of the one or more services has its own corresponding usage threshold. In some embodiments the one or more services consists of a single service. In some embodiments the one or more services is a plurality of services. When usage of a respective service is within the corresponding usage threshold, the respective service is maintained in the active state. When usage of a respective service exceeds the corresponding usage threshold, the respective service is maintained in an inactive state.

The one or more programs further comprise instructions for decrypting the first multi-character alphanumeric code using the first private key thereby forming a decrypted multi-character alphanumeric code. In some embodiments, the decrypted multi-character alphanumeric code comprises a unit identifier field, a counter field and a payload. The one or more programs further comprise instructions for comparing the content of the unit identifier field to the first unit identifier. The one or more programs further comprise instructions for comparing the content of the counter field to the first counter. When the unit identifier field matches the first unit identifier and the counter field is within a first threshold distance of the first counter, the payload is analyzed to adjust the usage threshold of a first service in the one more services, where this first service is specifically identified by the payload. In accordance with the first multi-character alphanumeric code, this usage threshold is adjusted by an amount specified by the payload, and the first counter is advanced by a predetermined increment. The advanced first counter is then stored in the memory of the first device (e.g., destination device) for later usage.

In some embodiments, the payload further comprises a service field that identifies the service and the payload comprises an amount field that specifies the amount. In such embodiments, adjustment of the corresponding usage threshold of the first service extends the amount of time that the first service is operable in the active state.

In some embodiments, the first multi-character alphanumeric code is associated with a rent-to-own plan for the electronic device. In some embodiments, the first multi-character alphanumeric code is associated with a continuous rental plan for the electronic device.

In some embodiments, the one or more services consists of a single service, and the active state of the single service is a powered state of the electronic device and usage of the first service is evaluated against (i) the passage of time of possession of the electronic device by a user irrespective of an amount of active use of the electronic device, (ii) an amount of time that the single service is in the powered state, (iii) an amount of energy used or generated by the electronic device, or (iv) an amount of energy stored by the electronic device.

In some embodiments, the one or more services consist of a single service, and the active state of the single service is a powered state of the electronic device. In some such embodiments, the electronic device is configured to power a plurality of appliances that is in electrical communication with the electronic device when the electronic device is in the powered state. In some such embodiments, the one or more processors comprise a master processor and an appliance in the plurality of appliances includes a slave processor responsive to instructions from the master processor to regulate between an enabled (powered) state and a disabled (non-powered) state.

In some embodiments, the electronic device does not include a SIM card and does not have access to a cellular network.

In some embodiments, the electronic device further comprises a display, and the one or more programs further comprise instructions for displaying a credit commensurate with the amount specified by the payload upon determination that the unit identifier field matches the first unit identifier and the counter field is within the first threshold distance of the first counter.

In some embodiments, the electronic device further comprises a rechargeable battery and a plurality of power ports. Each respective power port in the plurality of power ports is in electrical communication with the battery and is configured to power an apparatus when the first service is in the active state and configured to not power an apparatus when the first service is in an inactive state. Examples of such an apparatus include, but are not limited to, lights, mobile telephones, smart phones, radio, laptop computers, and tablet computers. In some such embodiments, the electronic device further comprises an energy capture device (e.g., one or more solar panels) that is in electrical communication with the rechargeable battery.

In some embodiments, the electronic device comprises a plurality of private keys and the one or more programs selects a new first private key from among the plurality of private keys in response to a reset. In some embodiments, the reset is a predetermined keypad sequence entered at the human interface device, and the predetermined keypad sequence is also stored in a nonvolatile portion of the memory.

In some embodiments, the first counter is an integer that represents a number of multi-character alphanumeric codes entered at the human interface device.

In some embodiments, when the when the counter field is outside a second threshold distance of the first counter, the first key is no longer used to decrypt alphanumeric codes entered at the human interface device. For example, in some embodiments the second threshold distance is 3, such that when difference between the counter field and the first counter is more than 3, the counter field is deemed to fail to match the first counter by more than a second threshold distance. In some such embodiments, when this condition arises, a new key pair associated with the device from among a plurality of key pairs associated with the device is used to encrypt and decrypt multi-character alphanumeric codes.

In some embodiments, the one or more services comprise a plurality of services.

Another aspect of the present disclosure is a non-transitory computer readable storage medium storing one or more programs configured for execution by one or more processors of a single electronic device. The one or more programs comprising instructions for evaluating usage of each respective service in one or more services operable on the single electronic device against a corresponding usage threshold. When usage of the respective service is within the corresponding first usage threshold, the respective service is maintained in an active (e.g., powered) state. When usage of the respective service exceeds the corresponding usage threshold, the respective service is maintained in an inactive (e.g. non-powered) state. A first multi-character alphanumeric code received by a human interface device of the single electronic device is decrypted using a first private key associated with the single electronic device thereby forming a decrypted multi-character alphanumeric code. The decrypted multi-character alphanumeric code comprises a unit identifier field, a counter field and a payload. The content of the unit identifier field is compared to a first unit identifier stored at the single electronic device. The content of the counter field is compared to a first counter stored at the single electronic device. When the unit identifier field matches the first unit identifier and the counter field is within a first threshold distance of the first counter, the payload is analyzed to adjust the usage threshold of a first service in the one more services identified by the payload by an amount specified by the payload, and the first counter is advanced by a predetermined increment. In some embodiments, the counter field is within a first threshold distance of the first counter if they match or differ by one.

Another aspect of the present disclosure provides a server comprising one or more processors, a plurality of data elements, and memory. Each respective data element in the plurality of data elements is for a corresponding device in a plurality of device. Each respective data element in the plurality of data elements comprises a unique identifier, a unique serial number, and a private key that are each uniquely associated with the corresponding device. The memory stores one or more programs to be executed by the one or more processors. The one or more programs comprise instructions for receiving a registration request for a first device in the plurality of devices from a first origination. The registration request includes a serial number and a mobile station international subscriber directory number (MSISDN) for an entity in possession of the first device. The first device is not addressable by the MSISDN and the registration request is associated with rate information for the first device. The MSISDN and rate information is stored for the first device in the data element associated with the first device when the serial number in the registration request matches the serial number in the data element. A payment message is received from a second origination. The payment message comprises an MSISDN number, a unique identifier, and an amount paid. The unique identifier is used to identify the first device in the plurality of device. Upon identification of the first device, the one or more programs further comprise instructions for forming a multi-character alphanumeric code comprising a first portion, a second portion and a third portion. The first portion identifies an amount of a service in accordance with the payment message. The second portion comprises the serial number of the first device. The third portion comprises a first counter associated with the first device. The multi-character alphanumeric code is encrypted using a key uniquely associated with the first device thereby forming an encrypted multi-character alphanumeric code. The encrypted multi-character alphanumeric code is communicated to an MSISDN number associated with the first device thereby enabling a user associated with the first device to maintain a first service run by the first device in an active (e.g., powered) state. For instance, in some embodiments this constitutes permitting the first device itself to be powered. Further, the first counter is associated with the first device is advanced by an increment. In some embodiments the increment is one or negative one to reflect a count of one. However, any prearranged increment may be used as long as the server and the first device use the same increment. In some embodiments, the multi-character alphanumeric code further comprises a fourth portion that identifies a service type. In some embodiments, the first origination is a sales registration application running on a computer device. In some embodiments, the second origination is a USSD server. In some embodiments, the first system does not have access to a cellular network.

In some embodiments, the communicating comprises sending an SMS message to the MSISDN number and the SMS message includes the encrypted multi-character alphanumeric code. In some such embodiments, the encrypted multi-character alphanumeric code extends the amount of time that the first service run by the first device is operable in the active state. In some embodiments, the encrypted multi-character alphanumeric code is associated with a rent-to-own plan for the first device. In some embodiments, the encrypted multi-character alphanumeric code is associated with a continuous rental plan for the first device. In some embodiments, the first device is configured to power a plurality of appliances that is in electrical communication with the first device when the first service is in the active state. In some embodiments, the first device does not include a SIM card or access to a cellular network. In some embodiments, the first device comprises a rechargeable battery, and a plurality of power ports, with each respective power port in the plurality of power ports in electrical communication with the battery and configured to power an apparatus when the first service run by the first device is in the active state. In some such embodiments, the apparatus is a light, a mobile telephone, a radio, a laptop computer, or a tablet computer. In some such embodiments, the first device further comprises an energy capture device (e.g., solar panel) that is in electrical communication with the rechargeable battery.

Another aspect of the present disclosure is a non-transitory computer readable storage medium storing one or more programs configured for execution by one or more processors. The one or more programs comprise instructions for receiving a registration request for a first device in a plurality of devices from a first origination. The registration request includes a serial number and a mobile station international subscriber directory number (MSISDN) for an entity in possession of the first device. The first device is not addressable by the MSISDN and the registration request is associated with rate information for the first device. The MSISDN and rate information for the first device is stored in a data element associated with the first device when the serial number in the registration request matches a serial number in the data element. A payment message from a second origination is received. The payment message comprises an MSISDN number, a unique identifier, and an amount paid. The unique identifier is used to identify the first device in the plurality of devices. Upon identification of the first device, the one or more programs further comprise instructions for forming a multi-character alphanumeric code comprising a first portion, a second portion and a third portion. The first portion identifies an amount of a service in accordance with the payment message. The second portion comprises the serial number of the first device. The third portion comprises a first counter associated with the first device. The multi-character alphanumeric code is encrypted using a key uniquely associated with the first device thereby forming an encrypted multi-character alphanumeric code. The encrypted multi-character alphanumeric code is communicated to an MSISDN number associated with the first device thereby enabling a user associated with the first device to maintain a first service run by the first device in an active state. The first counter associated with the first device is advanced by an increment. In some embodiments, the first origination is a sales registration application running on a computer device. In some embodiments, the second origination is a USSD server. In some embodiments, the first device does not have access to a cellular network. In some embodiments, the communicating comprises sending an SMS message to the MSISDN number, and the SMS message includes the encrypted multi-character alphanumeric code. In some such embodiments, the encrypted multi-character alphanumeric code extends the amount of time that the first service running on the first device is operable in the active state. In some such embodiments, the encrypted multi-character alphanumeric code is associated with a rent-to-own plan or a continuous rental plan for the first device. In some embodiments, the first device is configured to power a plurality of appliances that is in electrical communication with the first device when the first service is in the active state. In some embodiments, the first device does not include a SIM card or access to a cellular network. In some embodiments, the first device comprises a rechargeable battery, and a plurality of power ports, with each respective power port in the plurality of power ports in electrical communication with the battery and configured to power an apparatus when first service is in the active state. Examples of an apparatus include, but are not limited to, lights, mobile telephones, radio, laptop computers, tablet computer, and smart phones. In some embodiments, the non-transitory computer readable storage medium further comprises an energy capture device (e.g., one or more solar panels) that is in electrical communication with the rechargeable battery.

Thus, these methods, systems, and non-transitory computer readable storage medium provide for the distribution of devices (e.g., appliances) to households that cannot afford such devices without risk of loss to appliance owners.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 is a block diagram illustrating a solar power generation system, in accordance with some implementations.

FIG. 2 is a block diagram illustrating a network environment in which a solar power generation system resides, in accordance with some implementations.

FIG. 3 is a block diagram illustrating a destination device (e.g., controller) for controlling operation of a solar power generation system, in accordance with some implementations.

FIGS. 4A and 4B are front and bottom illustrations of a destination device (e.g., controller), in accordance with some implementations.

FIG. 5 is a block diagram illustrating a middleware server for key management for allocation of destination device resources using multi-character alphanumeric codes for the destination device (e.g., controller), in accordance with some implementations.

FIGS. 6A, 6B, 6C and 6D are flow diagrams illustrating a method for managing allocation of destination device resources using a server of a utility access system, in accordance with some implementations.

FIGS. 7A, 7B, and 7C are flow diagrams illustrating a method for managing usage data of a utility access system to restrict usage of a destination device, in accordance with some implementations.

### DETAILED DESCRIPTION

Reference will now be made in detail to implementations of the present application as illustrated in the accompanying drawings. The same reference indicators will be used throughout the drawings and the following detailed description to refer to the same or like parts. Those of ordinary skill in the art will realize that the following detailed description of the present application is illustrative only and is not intended to be in any way limiting. Other embodiments of the present application will readily suggest themselves to such skilled persons having benefit of this disclosure.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The implementations described herein provide various technical solutions to destination device (e.g. appliance) usage restriction. In one implementation, such usage restrictions allow for the distribution of advanced solar power generation devices to households that cannot afford to buy such devices, without risk of loss of such devices.

Devices, such as electrical appliances as well as systems for autonomous production and storage of electricity, are often cost prohibitive, excluding a large portion of the population from using those devices. While many are unable to pay the large upfront costs involved with purchasing electrical devices outright, those people may be able to pay for such devices via an installment payment plan (e.g., a rent-to-own plan or a continuous rental plan). Electronic device providers may have interests that run counter to device users at times in that the device providers desire to be paid in full for their goods. Device providers may prefer full payment of a purchase cost for a device upfront, thus guaranteeing payment. Installment plans may be less attractive to a provider, as the provider assumes certain risk that the electronic device user (e.g., customers, subscribers, etc.) will default on their payment plan. Device providers may be more willing to offer devices via installment plans if the risk of non-payment is mitigated.

A device usage monitoring system may provide such mitigation by selectively enabling or disabling a device or collection of devices based on the status of payments made by the user for the device(s) and tracked usage of the device(s). When device usage exceeds a usage threshold that is set based on the current status of payments for the device, the device is disabled by the device usage monitoring system. The usage threshold may also be considered a balance of available usage (e.g., money credit) that is subtracted from, where the usage threshold is exceeded and the device is disabled when usage fees exceed a current balance. The device may be re-activated when payments for the device become current. Because the device is non-functional or partially non-functional when payments are not current, users are more likely to make timely payments. Device providers may be more willing to provide devices via installment payment plans based on this knowledge, making the devices available to a larger segment of the population. Moreover, in some implementations, device providers provide such devices without any requirement that customers pay off the cost of the devices. Thus, in such implementations, customer payments are for access to such devices, not installments.

Devices may take any number of forms and may include devices that provide electricity, devices that store electricity, devices that use electricity, or other devices that rely on chemical energy, mechanical energy, nuclear energy, or are otherwise powered that can be placed into an active or inactive state. In some embodiments such devices run a number of different services and each such service can be placed in an active or inactive state. In some embodiments such devices run a single service (the use of the device itself) and the service can be placed in an active or inactive state. In such embodiments, the active site is a powered on stated whereas the inactive state is either a powered off state or a partially disabled state. An example of a partially disable state is the case of a device that is a light, and the partially disabled state only permits a dim light whereas the active state allows a range of different light settings. Another example of a partially disable state is the case of a device that is a television, and the partially disabled state only permits a single emergency channel to be viewed whereas the active state allows a range of television channels to be viewed.

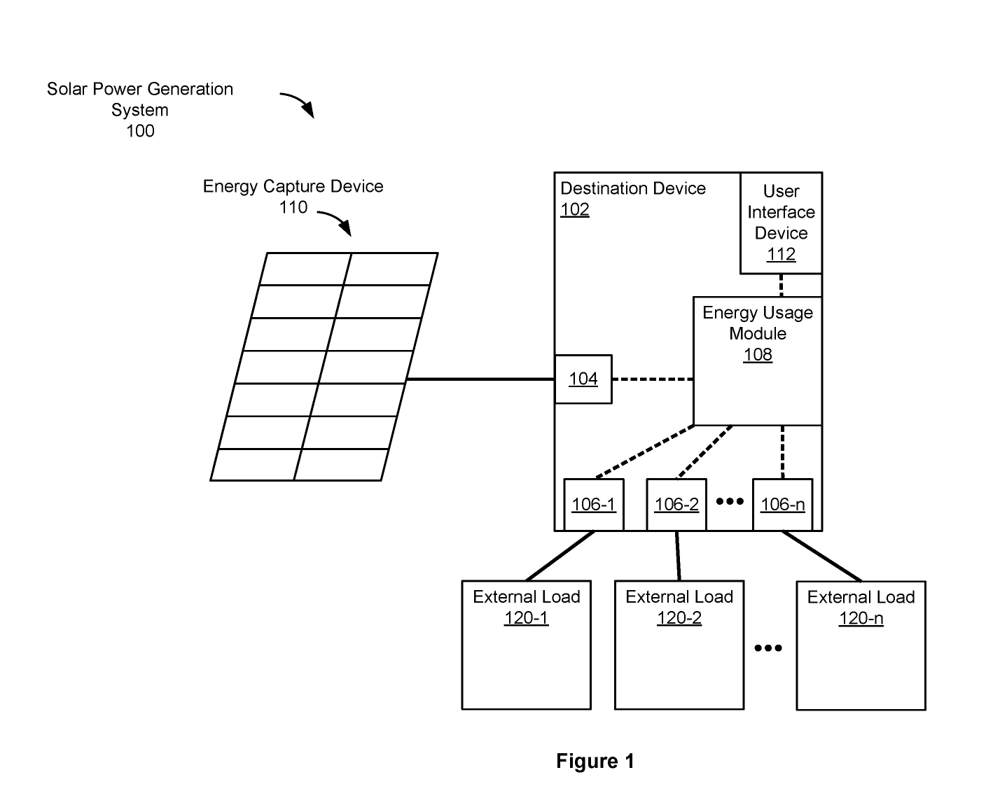

FIG. 1 is a block diagram depicting an destination device usage monitoring system embodied as a power generation system 100, in accordance with some implementations. The solar power generation system 100 includes an energy utility access device such as a destination device 102 (e.g., controller), an energy capture device 110, and one or more external loads 120 (e.g., external loads 120-1 . . . 120-n). Although not illustrated, solar power generation system 100 may include more than one energy capture device 110.

In some implementations, the energy capture device 110 is a solar panel constructed of one or more photovoltaic cells. The photovoltaic cells are made in any appropriate manner and made of any appropriate materials. For example, in some implementations, the photovoltaic cells are made of monocrystalline silicon, polycrystalline silicon, amorphous silicon, cadmium telluride, copper indium selenide/sulfide, GaAs-based multijunction material systems, or any other appropriate material or combination of materials.

The external load 120 is any suitable electrical load that receives electrical power from the energy capture device 110 via the destination device 102. In some implementations, the external load is an electrical device, such as a light (e.g., a lantern, flashlight, or any other type of light), a mobile telephone, a radio, a laptop computer, a tablet computer, a handheld personal digital assistant (PDA), a battery charger, or any other appropriate electrical device or appliances. In some implementations, the external load 120 is an energy storage device, such as a rechargeable battery or a capacitor, such as a battery of an electrical device (e.g., a lantern, flashlight, mobile telephone, computer, radio, etc.). In some implementations, the external load 120 is an appliance such as a heater or an air conditioner.

In some implementations, the external load 120 is a direct current (DC) load. In some implementations, the external load 120 is an alternating current (AC) load. Where the external load 120 is an AC load, the destination device 102 includes power conversion components (e.g., an inverter) to convert DC power produced by the energy capture device 110 to the appropriate AC power required by the load. Where the external load 120 is an active power grid (or other active AC power line), the power conversion components of the destination device 102 are capable of supplying AC current in the phase, frequency, voltage, and/or current required by the external load 120.

As shown in FIG. 1, the destination device 102 (e.g., controller) includes a power input 104, a power output 106 (e.g., power outputs 106-1 . . . 106-n), an energy usage module 108, and a human interface device 112.

The destination device 102 is configured to receive electrical power from the energy capture device 110 via the power input 104, and provide power to the external load 120 via the power output 106. The destination device 102 includes hardware and/or software for performing various types of power conversion, conditioning, and sensing tasks. In some implementations, the destination device 102 contains hardware and/or software suitable for sensing electrical characteristics of the energy capture device 110 and for adjusting the resistance of the load that is driven by the energy capture device. In some implementations, the destination device 102 contains hardware and/or software for performing maximum power point tracking (MPPT) or other forms of solar cell efficiency optimization.

The power input 104 connects the destination device 102 to the energy capture device 110. While FIG. 1 illustrates a destination device with a single power input 104, in some implementations, additional power inputs are included. In some such cases, the destination device 102 treats each connected energy capture device independently. In other such cases, the destination device 102 treats the connected energy capture devices collectively. Where multiple energy capture devices are treated collectively, they may be connected in serial, parallel, or any combination of serial and parallel connections. In some implementations, the destination device itself can electrically connect the multiple energy capture devices in a suitable manner (e.g., in series, parallel, etc.) based on, for example, the respective environmental conditions of the respective energy capture devices.

The power output 106 connects the destination device 102 to the external load 120. While FIG. 1 illustrates multiple power outputs 106-1 . . . 106-n and multiple corresponding appliances or external loads 120-1 . . . 120-n, for ease of description, the present discussion frequently refers to a single power output 106 and a single external load 120. One will also appreciate that the destination device may have a single power output in some implementations. In various implementations, the system is configured to power a plurality of appliances (e.g., external loads 120-1 . . . 120-n) that are in electrical communication with the system when the system is in the active state, in which case, destination device 102 includes one or more processors serving as master processors and an appliance in the plurality of appliances includes a slave processor responsive to instructions from the master processor(s) to regulate between the active (e.g., powered) state and the inactive (e.g., unpowered) state of the system.

In some implementations, a destination device usage monitoring system may be responsive to a single device or may function with a network of devices. FIG. 1 depicts a network of devices responsive to one or more destination device usage monitoring systems. The network includes an energy capture device 110 in the form of a solar panel 110, a charge destination device 102, and a plurality of appliances (e.g., external loads 120-1, 120-2 . . . 120-n), which may represent a battery, a light, a fan, a television, a refrigerator, a smart phone, a laptop computer, an electronic pad, etc. Each of the depicted devices may include an autonomous destination device usage monitoring system similar to that found in destination device 102. Autonomous destination device usage monitoring systems may individually monitor usage of associated devices, accept codes for those appliances, and place the associated devices in enabled or disabled states.

In other implementations, a destination device usage monitoring system is centralized, having one master processor (e.g., within destination device 102) and having several slave processors found within each of one or more devices (e.g., external loads 120-1, 120-2 . . . 120-n). Codes for each of the devices or the network as a whole may be received from a middleware server via messaging system as discussed below. In some implementations, payments are made for the entire network of devices. In those cases, when usage of the devices (or services provided by the devices) exceeds the usage threshold, the master processor sends signals to the slave processors instructing the slave processors to place the devices into an inactive (e.g., disabled state). In another implementation, the master processor coordinates payments for each of the devices in the network individually. In those cases, usage for each of the devices is tracked by the master processer, and the master processor instructs that individual devices be placed into an inactive state by their associated processor when usage of those devices exceeds the usage threshold. The usage threshold for each device may be extended individually through receipt of valid payment codes associated with those devices.

The energy usage module 108 is coupled to the power output 106 and, optionally, the power input 104, and performs energy logging and reporting functions. In some implementations, the energy usage module 108 monitors and records the amount of energy consumed by the external load 120. In some implementations, the energy usage module 108 monitors and records operational data related to the solar power generation system 100, including, for example, an amount of power captured by the energy capture device 110 for a given time frame (e.g., a day), times at which certain external loads were provided with power (and durations that power was provided to the external loads), environmental conditions associated with the solar power generation system 100 (e.g., temperatures, sun rise/set times, humidity, etc.), and the like.

Human interface device (e.g., keypad) 112 is configured to receive a first multi-character alphanumeric code.

FIG. 1 can be understood as both a functional description of the solar power generation system 100, as well as one exemplary implementation of the components present in an exemplary system. While the energy capture device 110, the destination device 102, and the external load 120 are shown in FIG. 1 as separate, connected, components, this particular arrangement is merely exemplary, and these components may be combined in various manners. For example, in some implementations, the destination device 102 is combined with the energy capture device 110 in a common housing or structure. In some implementations the destination device 102 is combined with one or more of the external loads 120-1 . . . 120-n in a common housing or structure. In some implementations, the energy capture device 110, the destination device 102, and one or more of the external loads 120-1 . . . 120-n are all combined in a common housing or structure.

Energy usage module 108 is configured to place a service hosted by the destination device in an inactive state when usage of the service exceeds a usage threshold amount. In some implementations, the service is the destination device 102 itself, or in other words the operation of the destination device. In some implementations, the destination device is connected to a power output 106. Usage may be tracked in a variety of different ways. For example, usage may be tracked by the passage of time. In such a case, an installment plan may grant a user one month of usage of a device (or a service provided by the device) for each payment made. For instance, the device may have a first service that is a light and a second service is a radio. In this simple example, usage of the two different services may be separately tracked and each service may be place in an active (powered or enabled) state and an inactive (non-powered or disabled) state. In another example, usage may be tracked as an amount of time of active use (e.g., minutes, hours, days, months, etc.). In such a case, an installment plan may grant a user 20 hours of active use (e.g., television watching) for a $5.00 payment. In a further example, usage may be tracked as an amount of energy generated, stored, or used. In such a case, an installment plan may grant a user access to produce and use 1 kWh of energy using a solar powered energy generation/storage system for a $10.00 payment. Other metrics for device usage may also be utilized.

In addition to tracking usage of a device, energy usage module 108 tracks a usage threshold that determines how much the device may be used before the device is to be placed into a disabled state. In this example, usage of the device constitutes a service hosted by the device. In some implementations, the usage threshold is set according to the terms of an installment payment plan between a device provider and a user. In some implementations, the usage threshold is set according to a pay-as-you-go arrangement with a device provider and a user in which the user never pays off the device, but rather arranges to pay for a discrete amount of device usage, for instance, in accordance with any of the metrics disclosed herein. The usage threshold may be adjustable based on receipt of confirmation of payment to the application provider. For example, a user may agree to an installment payment plan for a television, where the user is permitted to use the television for $5.00 per month. The user pays $5.00 at the time of agreement and the usage threshold is set to one month from the time of the agreement. When the energy usage module 108 determines that the month has expired, and no additional payment confirmations have been received, the energy usage module 108 places the television in an inactive (e.g., disabled) state. Upon receipt of a payment confirmation, the energy usage module 108 increments the usage threshold by one month. If a payment confirmation for one month of usage is received by the device usage monitoring system while the television is still in an active (e.g., enabled) state, then the energy usage module 108 extends the usage threshold one month from the current usage threshold.

With continued reference to FIG. 1, some energy usage modules 108 in accordance with the present disclosure also support an installment plan pay-off feature. A user may decide to pay off the remaining balance of his installment plan instead of continuing to make installment payments. A special payment confirmation may be provided to the energy usage module 108 associated with the now-paid-off device indicating that the device has been paid for in full. Upon receipt of such a message, the energy usage module 108 allows continual use of the device without placing the device in an inactive (e.g., disabled) state. Such a feature is accomplished in a variety of ways including extending the usage threshold to infinity or beyond the useful life of the device, discontinuing monitoring of usage of the device, setting a flag instructing energy usage module 108 not to place the device in a disabled state when usage exceeds the usage threshold, or other mechanisms.

The energy usage module 108 may place a device (e.g., a service hosted by the device) in an inactive state in a variety of ways. For example, in implementations where the device is connected through an outlet 106, the energy usage module 108 may disconnect a device, from a power source, such that the device is completely disabled. The energy usage module 108 may completely disable a device via a number of other mechanisms as well. Such disablement constitutes placing a service hosted by the device into an inactive state. The energy usage module 108 may disable a device by placing the device in a state of diminished usefulness. Such a disabling allows some limited use of services of the device. In one example, a disabled television is limited to the display of a single channel or a subset of channels that are available when the television is in an enabled state (e.g., only a channel displaying a message prompting the user to buy more credit is viewable). In another example, a light device is limited to only a lowest brightness setting. In still another example, a fan is limited to a lowest speed setting. An amount of power generated, stored, or made available for use from a solar energy system may be limited (e.g., to 25% of enabled state) when a service hosted by the device is placed in an inactive state by a device usage monitoring system.

The destination device 102 incorporating energy usage module 108 may be used in a variety of contexts. For example, destination device 102 may be incorporated into an autonomous solar power system that can operate without needing a connection to any electrical grid (e.g., a system may be used in remote locations having no connection to a centralized power provider). The system may include a solar panel, a wind turbine, or other energy capture device. A charge controller may control transfer of that captured energy to one or more batteries. Power from the one or more batteries may be supplied to one or more devices via DC power or AC power via an inverter.

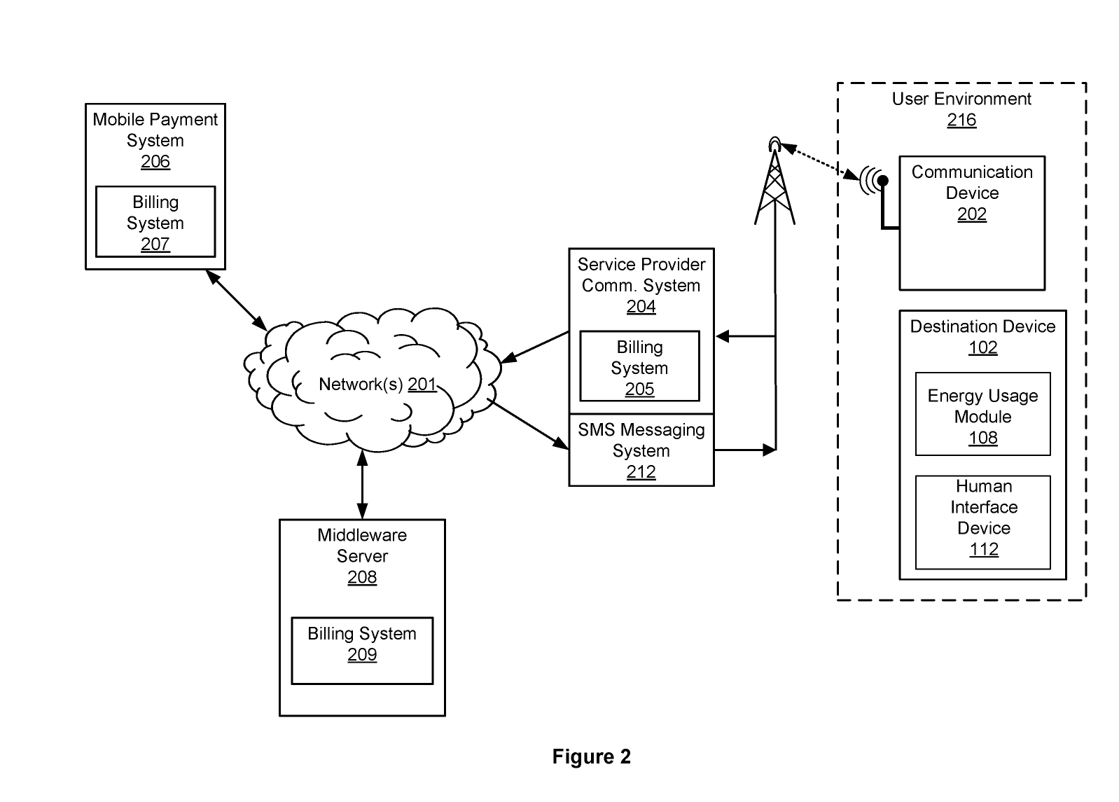

FIG. 2 is a block diagram illustrating a network environment or system for managing energy usage data of a utility access device such as a destination device 102, in accordance with some implementations. The network environment or system is generally comprised of a user environment 216 including a destination device (e.g., controller 102) and a communication device 202.

The network environment or system further comprises a service provider communication system 204, a mobile payment system 206, and a middleware server 208. The communication device 202 of the user environment 216 communicates (wired or wirelessly) with the service provider communication system 204. The service provider communication system, in turn, communicates with the mobile payment system 206 to allow a user to make a payment and obtain usage credit. The mobile payment system 206 communicates with the middleware server 208 to forward user payment information to the middleware server. When acceptable user payment information has been received, the middleware server 208 than issues payment information encoded in an encrypted token (e.g., a multi-character alphanumeric code) that is delivered to communication device 202 of user environment 216. In some implementations, the encrypted token is delivered by an SMS messaging system 212. This SMS message system may be part of the service provider communication system 204 as depicted in FIG. 2. However, in other embodiments not depicted in FIG. 2, this SMS messaging system may be part of another system separate from the service provider communication system 204.

In some implementations, the service provider communication system 204 includes one or more servers, routers or devices to provide centralized service for the service provider. For example, in some implementations, the service provider communication system 204 is configured to include a billing system 205. In some implementations, the billing system 205 is an integral part of the service provider communication system. However, one will appreciate that billing system 205 may be configured separate from the service provider communication system 204 and is addressable (wired or wirelessly) by service provider communication system 204 over network 201. In various implementations, the service provider communication system 204 utilized may be that of one or more commercial broadband and telecommunications providers (e.g., VERIZON, AT&T, Sprint, T-Mobile, VODAFONE, DIGICEL, etc.) in an otherwise conventional manner. Similarly, the billing systems and/or SMS messaging systems of such companies may also be utilized in an otherwise conventional manner.

In some implementations, the mobile payment system 206 includes one or more servers, routers or devices to provide centralized service for the service provider. For example, in some implementations, the mobile payment system 206 is configured to include a billing system 207, one or more a routers, and/or other processes. In some implementations, one or more processes (e.g., billing system 207) are configured to be integral to the service provider communication system. However, one will appreciate that such processes may be configured to be separate from the mobile payment system. In various implementations, the mobile payment system utilized may be that of one or more commercial mobile financial service providers (e.g., MPesa, TchoTchoMobile, KopoKopo, etc.) in an otherwise conventional manner. Similarly, the billing systems and/or SMS messaging systems of such companies may also be utilized in an otherwise conventional manner.

In some implementations, and with continued reference to FIG. 2, the user environment 216 further includes a communication device 202 that is associated with the same user as the destination device 102 and is in wired or wireless communication with the service provider communication system 204. In some implementations, the communication device 202 is a mobile phone, mobile computer (e.g., laptop computer, tablet computer, etc.), pager, or other device that provides wireless voice, text, or other data communication services. The user may utilize the communication device 202 to initiate or effect payment in order to obtain a multi-character alphanumeric code to be entered into destination device 102 to affect control over one or more services hosted by the destination device.

In some implementations, the communication device 202 and the destination device 102 are associated with the same user and/or the same user environment 216. The user environment 216 is intended to indicate that the communication device 202 and the destination device 102 illustrated in FIG. 2 are associated with the same user and/or are associated with the same account of the service provider. In some implementations, the user environment 216 corresponds to a particular geographic location (e.g., a user's house or property), though this is not necessary.

In some implementations, the service provider communication system 204 wirelessly communicates with the communication device 202. In some implementations, the service provider communication system 204 is coupled to one or more cellular antennas to which the communication device 202 connect in order to participate in wireless communications with other devices. In some implementations, the service provider communication system 204 is a base station corresponding to a cell of a cellular voice/data network.

While FIG. 2 shows only one user environment 216 that includes one destination device 102 and one communication device 202, one of ordinary skill in the art will recognize that a client environment 216 (and/or an account associated with the service provider) may include or be associated with additional communication devices 202 and destination devices 102.

Moreover, while FIG. 2 illustrates one service provider communication system 204, one billing system 206, and one user environment 216, it will be understood that additional instances of these or other components in FIG. 2 may be included as well. In particular, a service provider may include additional service provider communication systems (e.g., additional base stations). Further, a given service provider communication system will communicate with multiple user environments (each user environment optionally including one or more communication device and one or more destination device). Similarly, devices within a user environment 216 will communicate with multiple different service provider communication systems (e.g., with other base stations of a service provider), for example, if the communication device 202 and/or the destination device 102 change geographic locations.

Moreover, destination device 102 illustrated as a controller is just one example of a destination device that may be controlled in the manner disclosed in FIG. 2. In some embodiments, the destination device is not a controller. In some embodiments, the destination device is a light, fan, air conditioner, or television, or the like.

In some implementations, energy usage module 108 may receive payment confirmation in a variety of ways. In some implementations, energy usage module 108 tracks usage of the destination device 102, and/or services hosted by the destination devices and places the destination device 102 and/or one or more services hosted by the destination device in an inactive state when usage of the destination device 102 and/or such services exceeds a threshold amount (e.g., the destination device 102 provides more than a threshold amount of energy to a battery for storage). In such case, the destination device 102 maintains the inactive state until such time that a user enters a valid encrypted payment token in the form of a multi-character alphanumeric code. Stated another way, in some embodiments, a service hosted by the destination device 102 maintains the inactive state until such time that a user enters a valid encrypted payment token in the form of a multi-character alphanumeric code.

The destination device 102 also includes a human interface device 112 for data entry. The human interface device 206 is configured to receive a multi-character alphanumeric code. When a valid multi-character alphanumeric code is received via the human interface device 112, the energy usage module 108 is configured to adjust the threshold amount to allow additional usage of a device (e.g., the destination device 102 itself). Human interface device 112 entry devices may take a variety of forms, such as a keypad, touchscreen, and the like. Upon making an installment payment, a user may be provided a code through communication device 202. A user may type the code into the human interface device 112. The energy usage module 108 may verify the authenticity of the code in one of a variety of ways, as described further herein below. Upon verification of the authenticity of the code, the threshold amount of a service hosted by the destination device 102 is adjusted. For example, when a user types a valid code using the human interface device, the energy usage module 108 may extend the threshold amount such that the destination device 102 may be used in an active state for a longer period of time or may be made active for providing a further amount of energy to a battery for storage, and/or such that some other service hosted by the system is operable in the powered state for a longer period of time.

The code may be entered via a number of other mechanisms as well. A single button may be used, where the code can be entered in a Morse-code fashion. Multiple buttons could be arranged in series or in a keypad grid. A microphone could be used for receiving audible tones that convey the code (e.g., a mobile phone could be held close to the microphone, and tones representing a code could be played from the phone to the microphone). A barcode scanner could read an optical code printed on paper or displayed on a screen. Codes may also be entered wirelessly via an RFID scanning system (e.g., the system could include an RFID reader, where an RFID chip containing a code is placed close to the reader for transmission of the code) or an infrared receiver.

Codes for extending threshold amounts or for unlocking services hosted by devices for unlimited use may take a variety of forms. Tables 1 and 2 below depict example authorization codes. In some implementations, the code consists of 10, 11 or 12 digits. The final code is a concatenation of a number of values that are interpreted by energy usage module 108, to determine authenticity of the code and actions that should be taken by the system in response to receipt of a valid code or payment token (e.g., extending a usage threshold). The final code depicted in Table 1 is a concatenation of an amount of credit that was purchased by a user, a cryptographic signature (and others). The credit amount identifies an amount by which a threshold amount should be adjusted based on a received payment. All payments may move the threshold amount a uniform amount, or larger payments may move the threshold amount larger amounts than smaller payments. A credit amount may indicate that the device has been paid for in full, unlocking the device. Receipt of a certain number of payments or certain cumulative credit amounts may also unlock the device (e.g., the device may be unlocked upon receipt of a code for a final installment payment).

TABLE 1
First example of multi-character alphanumeric code

| Field | Description | Digits | Example |
|---|---|---|---|
| Service | The ID of the service purchased | 2 | 1 = Power |
| Type | | | per hour |
| Amount | The number of units purchased | 3 | 24 hours |
| Spinner | Number used to grant unique tokens | 3-5 | Random |
| Checksum | Used to verify the key ownership | 2 | CRC16 |

TABLE 2
Second example of multi-character alphanumeric code

| Field | Description | Digits | Example |
|---|---|---|---|
| Service | The ID of the service purchased | 2-10 | 1 = Power |
| Type | | | per hour |
| Amount | The number of units purchased | 2-10 | 24 hours |
| Counter | Used to verify the key ownership | 2-20 | Integer |
| Optional | Used to verify the key ownership | 2 | CRC16 |
| Checksum | | | |
| Unit | Number used to grant unique tokens | 2-20 | Integer |
| identifier | | | |

Referring to the example provided in Tables 1 and 2, in some implementations, the destination device 102 may be enrolled in one or more service programs, in which case, a predetermined portion of a decrypted multi-character alphanumeric code may include a service identifier (e.g., ServiceType field) that may indentify the type of service the user has purchased or enrolled in. In some embodiments, the destination device 102 is not enrolled in more than one service program (or in other words does not host more than one service program) and the multi-character alphanumeric code does not include a service type field. In some embodiments the service is a single service, operation of the destination device in an active state.

Referring to the example provided in Tables 1 and 2, in some implementations, the destination device 102 specifies an amount of a service (e.g., Amount field).

Referring to the example provided in Table 1 only, in some implementations, the multi-character alphanumeric code may include another predetermined portion that includes a spinner sequence (e.g. of 3-5 random digits) that may be used to grant unique tokens. As an alternative to the spinner sequence, the multi-character alphanumeric code of Table 2 provides a counter that, once initialized, is advanced each time a different multi-character alphanumeric code is generated for a given destination device 102 (e.g., controller). Thus, each destination device is associated with its own unique counter.

Referring to the example provided in Table 1, in some implementations, the multi-character alphanumeric code includes a checksum that is used to verify the encryption. In the example provided in Table 2, this checksum is optional.

Referring to the example provided in Table 1, in some implementations, the multi-character alphanumeric code includes a unit identifier that identifies the destination device 102 (e.g., controller) by its unique identifier.

When transmitted to a communication device, the multi-character alphanumeric code is encrypted by a cryptographic signature. The encryption may be generated in a variety of ways, such as via the public key infrastructure (PKI) (e.g., the cryptographic signature may be a digital signature created using a private key where the destination device 102 verifies the authorship of the code using a public (e.g., RSA) key), or via a shared secret key using cryptographic algorithms such as AES, SHA1, or SHA256, or SHA512 to generate the signature. Such a key may authenticate the author and verify that the message has not been tampered with, such as via an error-checking value. The signature may be entered at the same time as the rest of the code, or the processor may request the signature separately via a wireless communication protocol.

In some embodiments, each destination device 102 is assigned a plurality of key pairs. In one example, each device is assigned 10 key pairs. In each such key pair, one key is used to encrypt the multi-character alphanumeric code and the paired key is used to decrypt the multi-character alphanumeric code. The encryption keys of the key pairs are stored in a user account associated with the user at a site remote from the communication device 202 associated with the user (e.g., middleware server 208 and/or billing system 207). One such key is used, for example, by SMS messaging system 212 to encrypt the multi-character alphanumeric code. The decryption keys of the key pairs assigned to a user are stored in the destination device 102. When the user enters the encrypted multi-character alphanumeric code into the human interface device 112 of the destination device 102, the decryption key is used to decrypt the multi-character alphanumeric code. While a user, or more specifically a destination device 102, is assigned a plurality of key pairs, in typical embodiments only one such key pair is used at any given time to communicate encrypted multi-character alphanumeric codes. A new key pair may be used in the afore-described fashion when the counter stored by the destination device 102 does not agree with the counter maintained by the mobile payment system and/or middleware server 208 for the device as explained in more detail below.

In some implementations, when a multi-character alphanumeric code corresponding to a payment is issued, the multi-character alphanumeric code preferably adheres to one or more criteria. In one example the multi-character alphanumeric code adheres to any of the following criteria. In another example the multi-character alphanumeric code adheres to any 2, 3, 4, 5, or 6 of the following criteria. In another example the multi-character alphanumeric code adheres to all of the following criteria.
the multi-character alphanumeric code consists of 10, 11 or 12 digits;
the multi-character alphanumeric code is unique for the destination device 102 (e.g., controller);
a multi-character alphanumeric code entered into a wrong destination device 102 is not be accepted;
the units of credit are set by the service type (e.g., per hour, per day, etc.);
when decoded by the destination unit, the token's validity can be ascertained;
the multi-character alphanumeric code may only be successfully decoded by the destination device;
the multi-character alphanumeric code may only be used once by the destination device;
if the multi-character alphanumeric code is lost in transit the same multi-character alphanumeric code may be retransmitted;
a multi-character alphanumeric code may only pay for a single service type;
a different service type may be supported for each multi-character alphanumeric code;
after some period of time multi-character alphanumeric code values may be reused;
a predetermined multi-character alphanumeric code or pattern of such codes (e.g., predetermined multi-character alphanumeric codes) may signal the device has been paid off.

In further detail, some embodiments, a multi-character alphanumeric code comprises between 5 and 100 digits, between 6 and 50 digits, between 7 and 40 digits, between 8 and 20 digits, between 9 and 15 digits, 10 digits, 11 digits, 12 digits, 13 digits or 14 digits either before or after encryption.

In some embodiments, a multi-character alphanumeric code is unique for the destination device 102 (e.g., controller). That is, the multi-character alphanumeric code can only be used at a specific destination device 102. For example, if the multi-character alphanumeric code is used (e.g., entered) at a destination device other than the intended destination device, it will not extend the threshold of the other destination device.

In some embodiments, a multi-character alphanumeric code is unique for a collection of destination device (e.g., all destination devices 102 held by a particular entity such as a family or company). That is, the multi-character alphanumeric code can only be used at any of the destination devices 102 registered to the entity. If the multi-character alphanumeric code is used (e.g., entered) at a destination device other than the destination devices registered to the entity, it will not extend the threshold of the other destination device.

In some embodiments, the units of credit are set by the service type (e.g., per hour, per day, etc.). It will be appreciated that different service plans have different units of credit. Advantageously, in some embodiments, the multi-character alphanumeric codes of the present disclosure can support multiple service types, with the caveat that any particular multi-character alphanumeric code will be limited to a single service type identified by the multi-character alphanumeric code. For instance, by way of illustration, in some embodiments there are two service types hosted by a destination device, service “1” and service “2” and each multi-character alphanumeric code generated specifies whether it is associated with service “1” or service “2.” Moreover, the units of credits for service “1” and “service “2” may be the same or different. The units of credit for service “1” may be in dollars (or some other form of currency), days, months, or some other unit of time. Likewise, the units of credit for service “2” may be the same as that for service “1” or different from that of service “1”.

In some embodiments, when decoded by a destination device 102, the validity of the multi-character alphanumeric code can be ascertained. That is, the multi-character alphanumeric code must include sufficient information that a process, running on destination device 102 can validate the validity of the token. It will be appreciated, referring to FIG. 2, that in typical embodiments, destination device 102 does not have network access, in order to reduce the costs of the destination device. Thus, in such embodiments, the validity of the multi-character alphanumeric code is ascertained by one or more processes running on destination device 102 without the benefit of communication with the mobile payment system 206, middleware server 208 or service provider communication system 204.

In some embodiments, the token is decoded once it is entered into a destination device 102. As such, it is necessary in such embodiments that the token be successfully decoded by the destination unit 102. It will be appreciated, referring to FIG. 2, that in typical embodiments, destination device 102 does not have network access, in order to reduce the costs of the destination device. Thus, in such embodiments, the token must be encoded in such a manner that a process running on destination device 102 may decode the token without the benefit of communication with the mobile payment system 206, middleware server 208 or service provider communication system 204. In typical embodiments, this is done by using prearranged key pairs that are uniquely assigned to the destination device 102, where for each key pair an encryption key is stored remote from the destination device 102 and is used to encrypt the multi-character alphanumeric code and a corresponding decryption key is stored on the destination device 102.

In some embodiments, any given multi-character alphanumeric code may only be used once by the destination unit. That is, once the multi-character alphanumeric code has been entered at a destination device 102 and credit applied, the multi-character alphanumeric code may not be reused. This is not to say that if a multi-character alphanumeric code is lost transit that it may be retransmitted. Indeed, in typical embodiments, a multi-character alphanumeric code is retransmitted to a communication device on a recurring basis until such a time that a user receives the multi-character alphanumeric code and/or enters the multi-character alphanumeric code into an intended destination device 102.

In some embodiments, the multi-character alphanumeric code may only be used a predetermined number of times (e.g., two times, three times, four times, five times) by the destination device. That is, once the multi-character alphanumeric code has been entered at a destination device 102 and credit applied, the number of times the multi-character alphanumeric code may be reused is decremented from an initial value to the initial value minus one.

In some embodiments, when a multi-character alphanumeric code is lost in transit (e.g., from service provider communication system 204 to communication device 20), it is retransmitted. In some embodiments, a multi-character alphanumeric code is retransmitted to a communication device 202 from a service provider communication system 204 on a recurring basis until such a time that a user receives the token and/or enters the multi-character alphanumeric code into an intended destination device 102. In some embodiments, a multi-character alphanumeric code is retransmitted to a communication device 202 from a service provider communication system 204 when an operator at communication device 202 (or an automated process running on communication device 202) requests that the multi-character alphanumeric code be resent.

Referring to the example multi-character alphanumeric code of Table 2 above, in some embodiments a counter is used to count the number of unique multi-character alphanumeric codes that have been sent to a given destination device 102. That is, for each destination device 102 there is a counter. This counter is initialized to some initial value that is shared with the controller 102 and some process remote from the controller 102. The shared counter value is the same at this initialized step. In some embodiments, this initialization occurs only once when the device is distributed. In other embodiments, this initialization occurs on a recurring basis such as every yearly or monthly. Each time a mobile payment is made for a service run on a destination device 102 in the manner disclosed herein, the current counter of that destination device is placed in the multi-character alphanumeric code and then the counter is advanced by a predetermined increment (or decrement) such as “+1”, “+5”, “−1” and stored for later use in the next multi-character alphanumeric code to be sent to the particular destination device. When the multi-character alphanumeric code is decrypted at the destination device 102, this counter in the multi-character alphanumeric code is compared to the counter locally stored in the controller. If the counter locally stored in the controller is within a first distance threshold of the counter in the multi-character alphanumeric code, then the multi-character alphanumeric code is accepted and the usage threshold of a first service in the one more services identified by the multi-character alphanumeric code is adjusted by an amount specified by the multi-character alphanumeric code. For example, consider the case where this first distance threshold is one. If the counter in the multi-character alphanumeric code is “three” and the counter locally stored in the controller is “four”, then the condition is met and a first service in the one more services identified by the multi-character alphanumeric code is adjusted by an amount specified by the multi-character alphanumeric code. If, on the other hand, the counter in the multi-character alphanumeric code is “three” and the counter locally stored in the destination device is “five”, then the condition is not met and the first service identified by the multi-character alphanumeric code is not adjusted by an amount specified by the multi-character alphanumeric code. In some embodiments, when the counter field in the multi-character alphanumeric code is outside a second threshold distance (where the second threshold distance is larger than the first threshold distance) of the first counter, the current key is no longer used to decrypt alphanumeric codes entered at the human interface device. For example, in some embodiments the second threshold distance is 3, such that when the difference between the counter field and the locally stored first counter at the destination device is more than 3, the counter field is deemed to fail to match the locally stored first counter by more than a second threshold distance. In some such embodiments, when this condition arises, a new key pair associated with the destination device from among a plurality of key pairs associated with the destination device is used to encrypt and decrypt multi-character alphanumeric codes.

In some embodiments, the disclosed multi-character alphanumeric code only support (pay for) a single service type and, in such embodiments, do not include a service type identifier field. In some embodiments, the disclosed multi-character alphanumeric codes support (pay for) either of two service types and each respective multi-character alphanumeric code, in such embodiments, includes a service type identifier to identify which of the two service types the respective multi-character alphanumeric code represents. In some embodiments, the disclosed multi-character alphanumeric code support (pay for) three or more service types, four or more service types, five or more service types, or six or more services types and each respective multi-character alphanumeric code, in such embodiments, includes a service type identifier to identify which one of the service types the respective token is represents.

In some embodiments, the disclosed multi-character alphanumeric code support (pay for) multiple service types all within the same multi-character alphanumeric code. That is, in an exemplary embodiment, the multi-character alphanumeric code pays for a first service type and a second service type.

In some embodiments, after a predetermined period of time a multi-character alphanumeric code may be reused. This is advantageous because it helps to reduce costs. Rather than building a cache within destination device 102 that must store an unending number of multi-character alphanumeric code that have been decoded, to ensure that no multi-character alphanumeric code is ever reused, the cache size can be limited in some predetermined way. Any multi-character alphanumeric code value that is in the cache (or other storage form) cannot be reused. In some embodiments, multi-character alphanumeric code are cleared from the cache (or other storage form) after a predetermined period of time, such as one day, one week, one month or one year. In some embodiments, multi-character alphanumeric codes are cleared from the cache (or other storage form) on a first in first out basis and the cache (or other storage form) size is limited to a predetermined number of multi-character alphanumeric codes such as 10 multi-character alphanumeric codes, 100 multi-character alphanumeric codes, 500 multi-character alphanumeric codes, or 1000 multi-character alphanumeric codes.

In some embodiments, a series of multi-character alphanumeric codes entered at destination device 102 indicates that a predetermined event has taken place. For instance, in some embodiments, a series (e.g., two sequentially entered multi-character alphanumeric codes each having a predetermined code) indicates that the destination device 102 has been paid off and thus its usage is no longer governed by the threshold requirement. Other forms of events include a recall event (indicating that the destination device 102 is being recalled), a stolen event (indicating that the destination device 102 has been stolen), a bad credit event (indicating that the operator of destination device 102 has bad credit and that the controller 102 should be returned to the distributor), anew key event indicating it is time to switch to a new key pair, and a counter reset event indicating it is time to reset the counter. For any such respective event, a series of a single multi-character alphanumeric code, two sequential multi-character alphanumeric codes, three sequential multi-character alphanumeric codes, or more may be used to indicate the occurrence of the respective event.

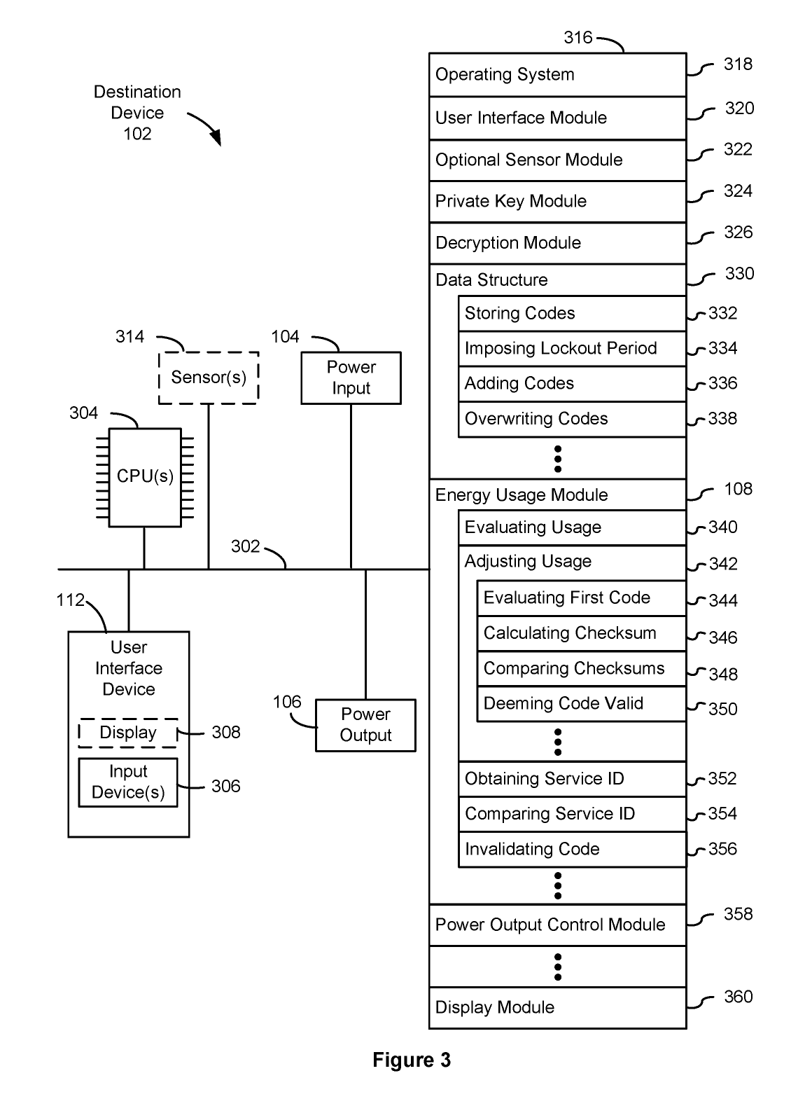

FIG. 3 is a block diagram illustrating a destination device 102, in accordance with some implementations. In some implementations, the destination device 102 is a handheld electronic device. For example, in some implementations, the destination device 102 is or is incorporated into, any of: a light (e.g., a lantern, flashlight, or any other type of light), a mobile telephone, a radio, a laptop computer, a tablet computer, a multiport power providing device or any other appropriate electrical device. In some implementations, the destination device 102 is used for controlling operation of a solar power generation system such as the solar power generation system 100 illustrated in FIG. 1. In some implementations, the destination device 102 is used for controlling operation of other power generation or transmission systems.

The destination device 102 typically includes one or more processors (e.g., CPUs 304), one or more optional sensors 314, one or more power inputs 104, one or more power outputs 106, a user interface 112 that includes an input device 306 and optionally a display 308, memory 316, and at least one communication bus 302 for interconnecting these components. Each communication bus 302 may include circuitry (sometimes called a chipset) that interconnects and controls communications between system components.

The one or more sensors 314 include sensors configured to detect electrical characteristics of various aspects of a solar power generation system of which the destination device 102 is part, and include any necessary electrical components, circuits, processors, and components (software or hardware) for sensing various electrical values. For example, in some implementations, the sensors 314 include sensors for detecting any of the following values: power consumed by one or more components of a solar power generation system (e.g., any internal or external components, or any combination of such components); current drawn by one or more components of the solar power generation system; a voltage difference between one or more components of the solar power generation system; and an open-circuit voltage of an energy capture device connected to the destination device 102 (e.g., a solar panel); resistance of a load. Other sensors are also included, in various implementations, for sensing and/or measuring other values.

With continued reference to FIG. 3, in some implementations, sensors 314 also include sensors for detecting other characteristics of a solar power generation system of which the destination device 102 is part, including, for example, ambient light conditions, ambient temperature conditions, and the like.

The one or more power inputs 104 include hardware (e.g., connectors, ports, electronic circuitry, etc.) and/or software (e.g., programs, executable instructions, firmware, embedded logic, etc.) that facilitate a mechanical and/or electrical connection between the destination device 102 and one or more energy capture devices (e.g., the energy capture device 110, FIG. 1). For example, in some implementations, the one or more power inputs 104 include a socket or plug (e.g., a coaxial DC power connecter) for connecting to a corresponding socket or plug of the energy capture device 110.

The one or more power outputs 106 include hardware (e.g., connectors, ports, electronic circuitry, etc.) and/or software (e.g., programs, executable instructions, firmware, embedded logic, etc.) that facilitate a mechanical and/or electrical connection between the destination device 102 and one or more external loads 120 (e.g., the external loads 120-1 . . . 120-n of FIG. 1). In some implementations, the one or more power outputs 106 include electrical circuitry that is used to change the electrical characteristics of a load connected thereto. For example, the one or more power outputs 106 include one or more variable resistors configured to be connected in series and/or in parallel with a connected load, and are used to change the effective resistance of the load being driven by the energy capture device. Such variable resistors (and/or other appropriate components) are used, for example, to adjust a load resistance in accordance with a maximum power point tracking (MPPT) algorithm. Such variable resistors (and/or other appropriate components) are also used, in some implementations, during recalibration cycles to adjust a load resistance experienced by an energy capture device when an external load is disconnected. For example, they can be used to allow the destination device 102 to vary the load resistance in order to measure the value of the resulting current and power (among other possible parameters) drawn from the energy capture device 110.

Memory 316 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. Memory 316, or alternately the non-volatile memory device within memory 316, includes a non-transitory computer readable storage medium. In some implementations, memory 316 or the computer readable storage medium of memory 316 stores the following programs, modules and data structures, or a subset thereof:
an optional operating system 318 that includes procedures for handling various basic system services and for performing hardware dependent tasks, as described herein, including:
a user interface module 320 that receives commands and/or inputs from a user via the user interface 306 (e.g., from the human interface device 112) and optionally provides user interface objects on a display (e.g., the display 308), the commands and/or inputs including a plurality of multi-character alphanumeric codes (e.g., payment multi-character alphanumeric codes);
an optional sensor module 322 for communicating with the one or more optional sensors 314 to receive sensed electrical values, calculate derived values, and programmatically couple the output of the one or more sensors 314 to other components of the destination device 102;
a private key module 324 for storing one or more keys uniquely associated with the destination device 102, the private key stored in at least a non-volatile portion of the memory;
a decryption module 326 for decrypting any encrypted codes (e.g., payment multi-character alphanumeric codes) entered by a user via the user interface module 320;
one or more optional data structures 330 that optionally store a plurality of multi-character alphanumeric codes that have previously been entered into the human interface device including those that have been determined by the decryption module to be valid (e.g., storing codes 332), as described herein, and may further include the following programs or subset thereof:
   A. imposing a lockout period when a predetermined number of alphanumeric codes are entered into the keypad within a predetermined time (e.g., imposing lockout period 334);
   B. adding a first multi-character alphanumeric code or the decrypted multi-character alphanumeric code to the plurality of multi-character alphanumeric codes (e.g., adding codes 336);
   C. overwriting a code in the plurality of multi-character alphanumeric codes when a number of codes in the plurality of multi-character alphanumeric codes reaches a predetermined code number limit (e.g., overwriting codes 338);
an energy usage module 108 for tracking energy usage of destination device (such as destination device 102) and/or services hosted by such devices and toggling them between an active and inactive state, where usage of the destination device may be evaluated against (i) the passage of time of possession of the destination device by a user irrespective of an amount of active use of the destination device, (ii) an amount of time that the destination device is in the powered state, (iii) an amount of energy used or generated by the destination device, or (iv) an amount of energy stored by the destination device, as described herein, and may further include the following programs or subset thereof:
   A. evaluating usage of the destination device against a usage threshold (e.g., evaluating usage 340), and when usage of the destination device is within a usage threshold, processor 304 permits the destination device to be in an active (e.g., powered) state, and when usage of the destination device exceeds the usage threshold, destination device is placed in an inactive (e.g., unpowered) state;
   B. in response to a determination by the decryption module that the first multi-character alphanumeric code is valid, adjusting the usage threshold of a service specified by the code by an amount specified by the code (e.g., adjusting usage 342)
a power output control module 358 that controls the power directed to power output 106;
a display module 360 that controls a display (e.g., display 308) of a credit commensurate with the amount specified by the first multi-character alphanumeric code upon determination by the decryption module that the first multi-character alphanumeric code is valid.

In some implementations, the destination device 102 may be enrolled in one or more service programs, and the usage threshold is associated with a first service program of the at least one service program, and the first service program is associated with a first service identifier, and one or more programs may further include instructions for:
obtaining a candidate service identifier from a second predetermined portion of the decrypted multi-character alphanumeric code (e.g., obtaining service ID 352);
comparing candidate service identifier to the first service identifier (e.g., comparing service ID 354); and
deeming the first multi-character alphanumeric code invalid when the candidate service identifier does not match the first service identifier (e.g., invalidating code 356).

In some implementations, the destination device 102 includes a subset of the components and modules shown in FIG. 3. Moreover, in some implementations, the destination device 102 includes additional components and/or modules not shown in FIG. 3.

In an aspect of the present disclosure, a destination device 102 is provided for controlling operation of a solar power system (e.g., an energy capture device or devices). The destination device comprises an input configured to receive electrical power from one or more energy capture devices, an output configured to provide electrical power to an external load, one or more processors, and a memory. One or more programs stored in the memory are configured to be executed by the one or more processors.

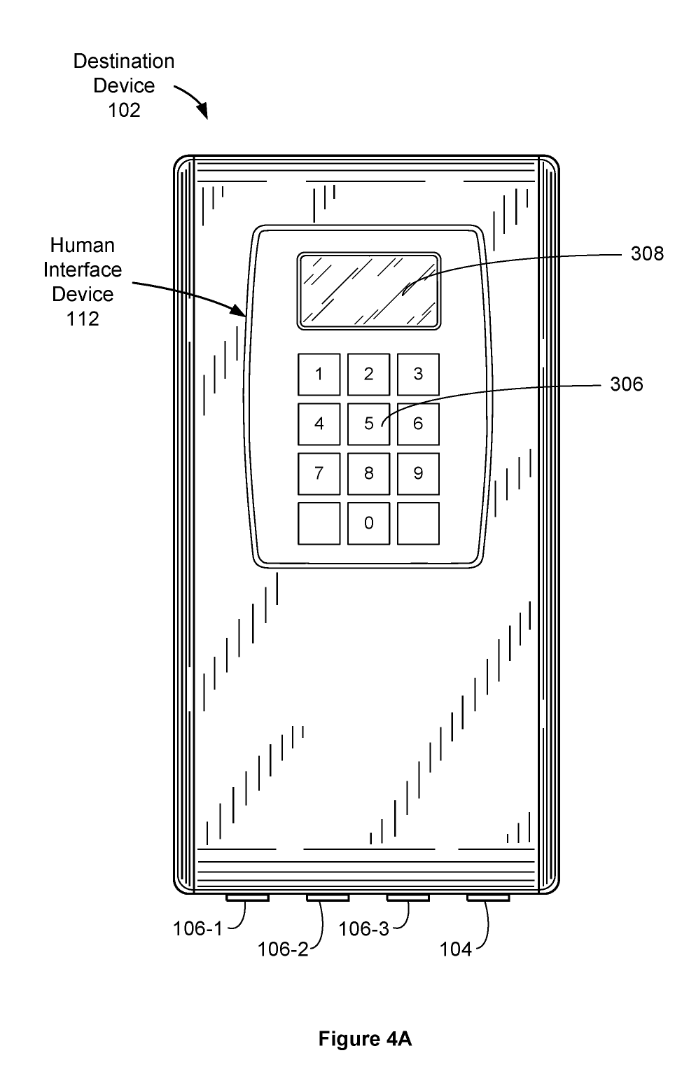

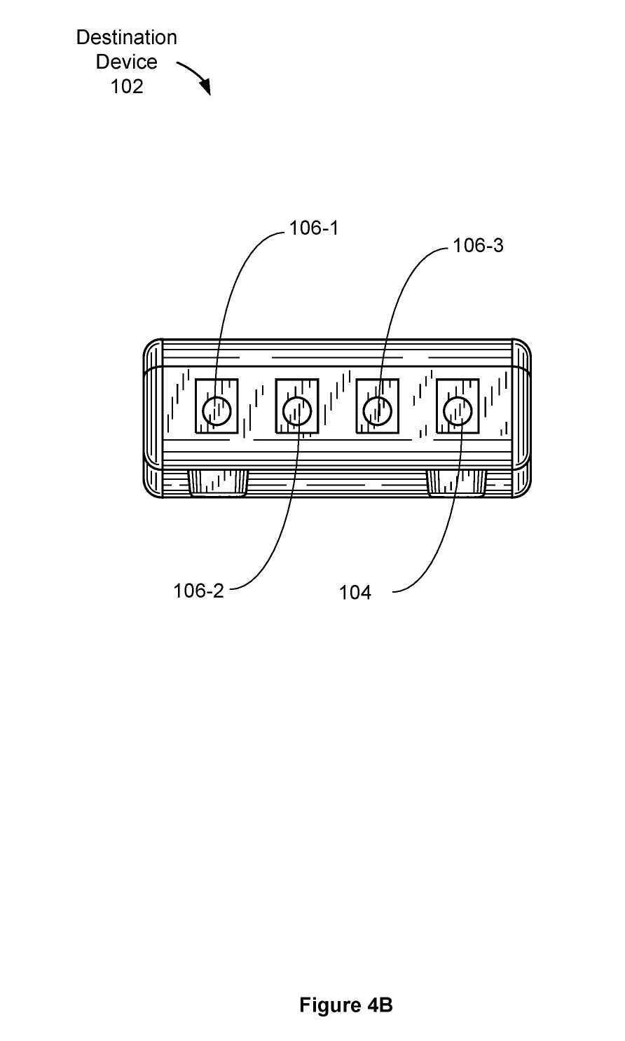

As shown in FIGS. 4A and 4B, in some implementations the destination device 102 includes a casing 402 that houses the various components of the destination device and supports human interface device 112 and any inputs (e.g., power input 104) and outputs (e.g., power outputs 106-1, etc.) for ready access for a user. As noted above, the human interface device includes one or more input devices (e.g., keys/keypad 306) and one or more displays 308.

In various implementations, preferably, destination device 102 does not include wireless capabilities. For example, multi-character alphanumeric codes and codes input by a user into the destination device allow the destination device to verify and allow energy usage without direct communication with a central server. Thus, in some embodiments, the destination device does not require a SIM card or other wireless or communications capabilities thus significantly reducing the manufacturing costs associated with the destination device.

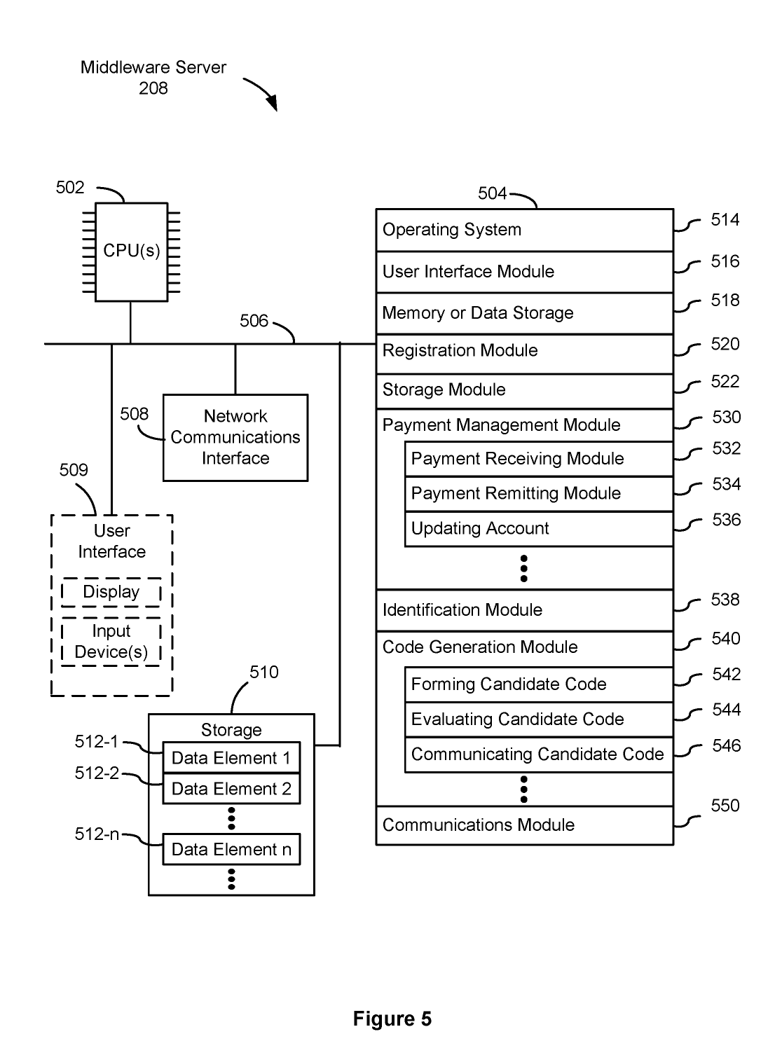

Attention is now directed to FIG. 5, which illustrates an exemplary middleware server 208 for managing usage data of a device, in accordance with some implementations. The middleware server 208 typically includes one or more CPUs 502, a memory 504, one or more optional network communications interface 508 (wired and/or wireless), an optional user interface 509 similar to the optional user interface 306, an optional storage 510 for storing billing data base such as historical usage and/or billing information and at least one communication bus 506 similar to communication bus 302 for interconnecting these components.

In some implementations, the network communications interface 508 is used for connecting (wired or wireless) the middleware server 208 to other systems, servers, routers or devices (e.g., service provider communication system 204, mobile payment system 205) in the network environment, for example, through a network 201 (FIG. 2). In some implementations, the network communications interface 508 is used for connecting (wired or wireless) the middleware server 208 to other computers or devices or to one or more communication networks, such as the Internet, other Wide Area Networks, Local Area Networks, Personal Area Networks, Metropolitan Area Networks, VPNs, local peer-to-peer and/or ad-hoc connections. For example, in some implementations, the network communications interface 508 connects the middleware server 208 to the service provider communication system 204 and/or mobile payment system 206 through the network 201 to receive energy usage data units from the destination device 102, and/or billing information for other services (e.g., voice/text/data services) provided to the given user by the service provider. As another example, in some implementations where the service provider communication system 204 includes a billing system 205, and/or when the mobile payment system 206 includes a billing system 207, the network communications interface 508 connects the middleware server 208 to the service provider communication system 204 and/or the mobile payment system 206 through the network 201 to receive billing and/or usage information from the billing system 205. The received information is stored in a memory or data storage 518 or in the optional storage 510.

In some implementations, the data storage 518 or storage 510 includes a plurality of data elements for a corresponding plurality of devices, in which each respective data element includes a unique identifier, a unique serial number, and a private key that are each uniquely associated with each corresponding device.

In some implementations, the received information includes a plurality of energy usage data units from an energy utility access device (e.g., the destination device 102). In some implementations, the received information includes a plurality of energy usage data units from a plurality of energy utility access devices.

Similar to memory 316, memory 504 can be solid state, non-volatile or other memory devices and includes a computer readable storage medium. In some implementations, memory 504 or the computer readable storage medium of memory 504 stores the following programs, modules and data structures, or a subset thereof:
an optional operating system 514 that includes procedures for handling various basic system services and for performing hardware dependent tasks;
an optional user interface module 516 that receives commands and/or inputs from a user via the optional user interface 509;
a registration module 520 for a registration request for a first system from a first origination (e.g., from a particular user environment 216 via a communication device 202) that includes a serial number and a mobile station international subscriber directory number (MSISDN) for a user in possession of the first device and rate information for the first device;
a storage module 522 for storing the MSISDN and rate information for the first device in the data element associated with the first device when the serial number in the registration request matches the serial number in the data element (one will appreciate that such information may also, or alternatively, be stored in storage 510 and/or data storage 518);
a payment management module 530 that manages payment for an end user in association with the identifier of the energy utility access device, in which a payment message is received from a second origination (e.g., service provider 204 or mobile payment system 206), wherein the payment message comprises an MSISDN number, a unique identifier, and an amount paid, as described herein, including:
   A. a payment receiving module 532 for receiving a payment from the end user that has been confirmed or verified by the service provider communication system 204 and/or mobile payment system 206), and which payment corresponds to at least a portion of the balance of the energy service account;
   B. a payment remitting module 534 for remitting a portion of the payment to an associated entity or entities such as the service provider system or mobile payment system;
   C. optionally or additionally, an account updating module 536 for updating the account of the end user to reflect the payment from the end user;
an identification module 538 that uses the unique identifier to identify a second device in the plurality of devices, whereupon identification of the second device;
a code generation module 540 for constructing a multi-character alphanumeric code to be used by the user and entered into human interface device 112 of destination device 102, as described herein, and including the following programs, modules and data structures, or subset thereof:
   A. forming a candidate multi-character alphanumeric code in which a first portion of the candidate multi-character alphanumeric code identifies a service type associated with the payment message, a second portion of the candidate multi-character alphanumeric code identifies an amount of the service type in accordance with the payment message, a third portion of the candidate multi-character alphanumeric code is randomly generated, and a fourth portion of the candidate multi-character alphanumeric code is a checksum computed using (i) at least a predetermined portion of the multi-character alphanumeric code and (ii) the private key that is uniquely associated with the second device (e.g., forming candidate code 542; also see Table 1 above);
   B. evaluating the candidate multi-character alphanumeric code for uniqueness against a plurality of test multi-character alphanumeric codes that have been previously sent to the second device, where the forming (A) and evaluating (B) are repeated until the candidate multi-character alphanumeric code does not match any multi-character alphanumeric code in the plurality of test multi-character alphanumeric codes (e.g., evaluating candidate code 544); and
   C. communicating the candidate multi-character alphanumeric code to an MSISDN number associated with the second device thereby enabling a user associated with the second device to maintain the second device in a usable state (e.g., communicating candidate code 546); and
an optional or additional communications module 550 for connecting the middleware server 208 to other devices via the one or more network communication interface 508 (wired or wireless) and one or more communication networks in order to send payment multi-character alphanumeric code 544 to the user via communication device 202.

In some implementations, the payment management module aggregates historic energy usage information. As noted above, there is no requirement that destination devices 102 have a SIM card or wireless connectivity, or even wired connectivity. In instances where there is connectivity with destination devices 102, however, energy usage data may be tracked and stored with the historic energy usage information in which case operational data may include one or more or any combination of the following:
a table identifying cellular radio towers to which the energy utility access device (e.g., destination device 102) is able to communicate;
a dataset containing voltage and current measurements for an energy capture device coupled to the energy utility access device;
a duration of use of a device, such as light, TV, charger, coupled to the energy utility access device;
an amount of power used by a device coupled to the energy utility access device;
a temperature of an environment of the energy utility access device;
an amount of energy captured by an energy capture device coupled to the energy utility access device;
a voltage-open-circuit value of an energy capture device coupled to the energy utility access device; and
an identifier, such as USB serial numbers or IMEI numbers of a phone, of a device coupled to the energy utility access device.

Again, as noted above, however, there is no requirement that such devices have a SIM card or wireless connectivity, thereby driving down production costs and allowing for better penetration in lower income regions. Thus, in some implementations where the middleware server 208 does not have networked access (wired or wireless) to destination device 102, the aggregating usage may include estimated energy usage information that is derived from prior payments in connection with the device.

In some implementations, the payment receiving module 532 receives a payment from an end user via a mobile telephone, an unstructured supplementary service data (USSD) or other devices. The remitting payment 536 remits the payment or a portion of the payment to an associated entity or entities. For example, in some implementations, the updating account module 536 remits a first portion of the payment to a distribution entity that distributes or sells the energy utility access device and/or other devices, and remits a second portion of the payment to a manufacturing entity that makes the energy utility access device and/or other devices (e.g., the immediate provider of the devices).

In some implementations, the optional or additional memory or data storage 510 is used to store information received from an energy utility access device (e.g., destination device 102) of the user environment 216 such as a plurality of energy usage data units from the energy utility access device, the communication device 202 of the user environment 216, the service provider communication system 204, and/or other devices. In some implementations, the optional or additional memory or data storage 510 is used to store a portion of the information received from these devices, and the optional or additional storage 510 is used to store the other portion of the information.

While FIG. 5 illustrates a middleware server 208 configured separately from the service provider communication system 204 and mobile payment system 206, a similar configuration applies to billing systems 205 or 207 that may be coupled to or embedded in the corresponding systems 204 or 206. In such implementations, for example, the service provider communication system 204 may have one or more centralized network communications interfaces which the billing system 205 shares with other components or devices in the service provider communication system 204. In some implementations, the billing system 205 may have an optional, additional or individual network communications interface similar to the network communications interface 508. In some implementations, an energy usage data management system may include both a middleware server 208 configured separately from the service provider communication system 204 and a billing system 205 embedded in the service provider communication system 204, where the middleware server 208 and the billing system 205 each performs a subset of desired functions.

Moreover, while FIG. 5 illustrates a middleware server 208 for managing energy usage, it can also include one or more other functions, for example, serving as a voice service billing system or a data service billing system. In some implementations, a voice service billing system or a data service billing system is configured separately from an energy usage billing system (e.g., billing system 206).

In some implementations, the middleware server 208 includes a subset of the components and modules shown in FIG. 5. Moreover, in some implementations, the middleware server 208 includes additional components and/or modules not shown in FIG. 5.

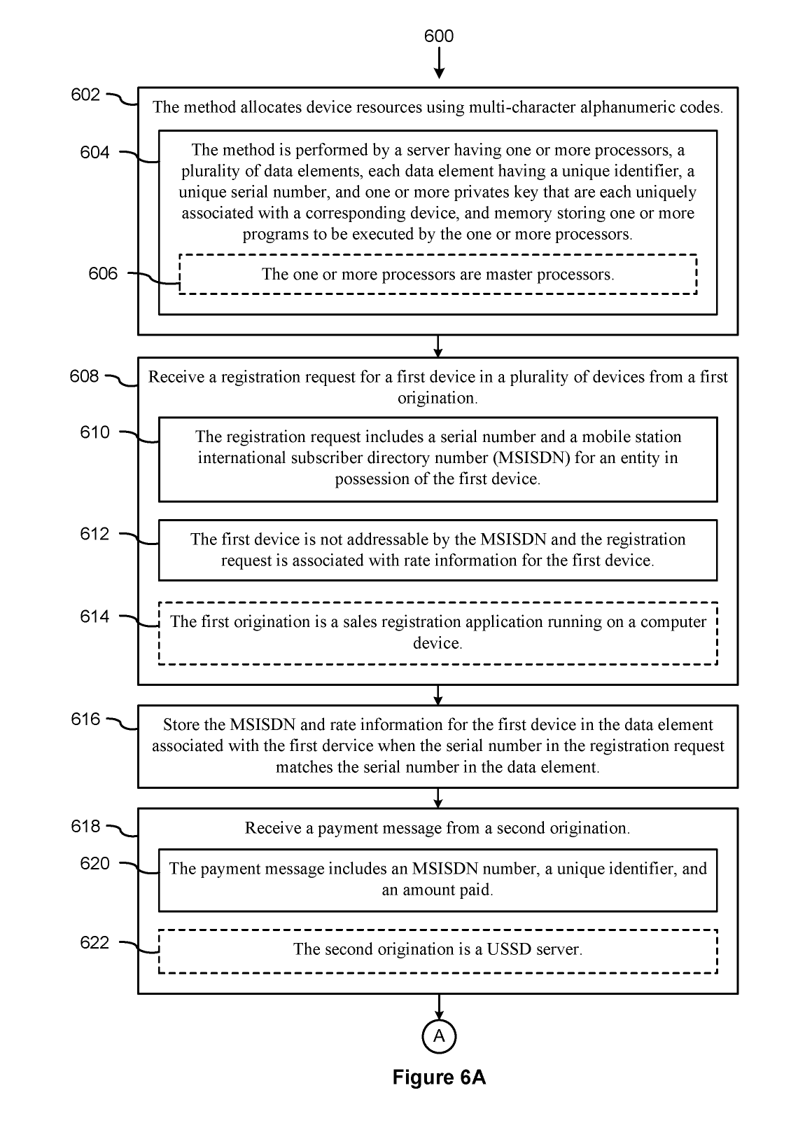

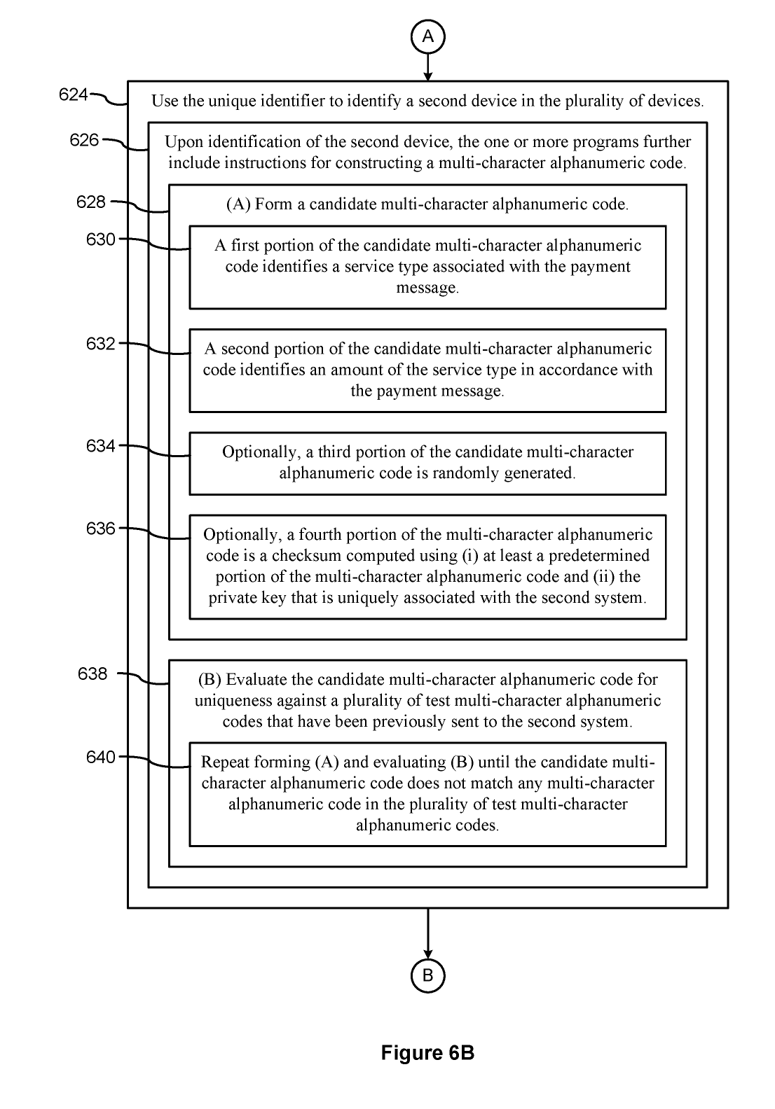

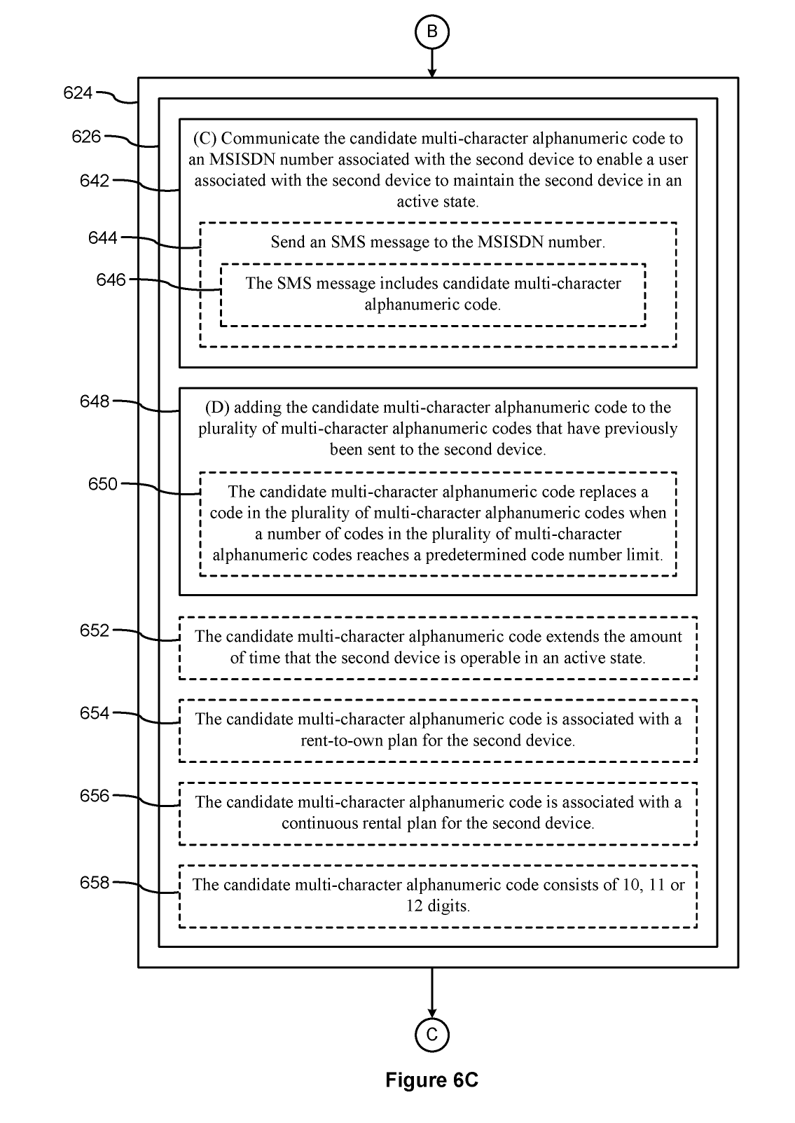

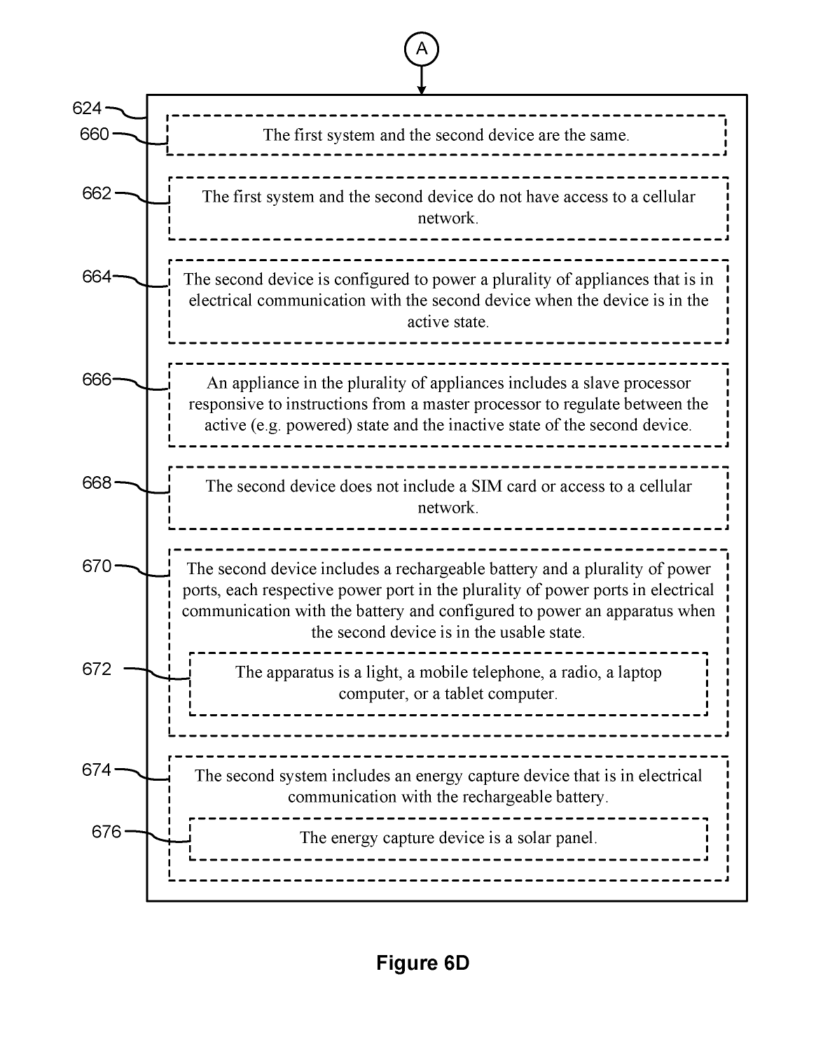

FIGS. 6A-6D are a flow diagram 600 depicting an example method 602 of allocating device resources performed with a server 604 (e.g., middleware server 208) that includes one or more processors (which may be master processers 606), a plurality of data elements corresponding to a plurality of devices including associated unique identifiers, serial numbers, and private keys, and memory storing one or more programs.

A registration request is received for a first device in a plurality of devices from a first origination (608). The registration request 610 includes a serial number and a mobile station international subscriber directory number (MSISDN) for an entity in possession of the first device. The first device is not addressable by the MSISDN, and the registration request is associated with rate information for the first device (612).

In some implementations, the first origination is a sales registration application running on a computer device (614).

The MSISDN and rate information for the first device is stored in one or more data elements associated with the first device when the serial number in the registration request matches the serial number in the one or more data elements (616).

A payment message is received from a second origination, other than the first origin (618). The payment message includes an MSISDN number, a unique identifier, and an amount paid (620). The second origination 622 may be a USSD server.

The unique identifier is used to identify a second device in the plurality of devices (624). In some embodiments, the first and second devices are the same device. In some embodiments, the first and second devices are the same destination device 102. In some embodiments, upon identification of the second device, the one or more programs construct a multi-character alphanumeric code (626).

A candidate multi-character alphanumeric code is formed (628). A first portion of the candidate multi-character alphanumeric code identifies a service type associated with the payment message (630). A second portion of the candidate multi-character alphanumeric code identifies an amount of the service type in accordance with the payment message (632). In some embodiments, a third portion of the candidate multi-character alphanumeric code is randomly generated (634). In some embodiments, a fourth portion of the candidate multi-character alphanumeric code (636) is a checksum computed using (i) at least a predetermined portion of the multi-character alphanumeric code and (ii) the private key that is uniquely associated with the second device.

In some embodiments, the candidate multi-character alphanumeric code is evaluated for uniqueness against a plurality of test multi-character alphanumeric codes that have been previously sent to the second device (638). In some embodiments, the forming (A) and evaluating (B) are repeated until the candidate multi-character alphanumeric code does not match any multi-character alphanumeric code in the plurality of test multi-character alphanumeric codes (640).

The candidate multi-character alphanumeric code is communicated to an MSISDN number associated with the second device thereby enabling a user associated with the second device to maintain the second device (or a service or one or more services hosted by the second device) in an active state (642). An SMS message may be sent to the MSISDN number, and the SMS message may include the candidate multi-character alphanumeric code (respectively depicted at 644 and 646).

The candidate multi-character alphanumeric code is optionally added to the plurality of multi-character alphanumeric codes that have previously been sent to the second device (648). The candidate multi-character alphanumeric code may optionally replace a code in the plurality of multi-character alphanumeric codes when a number of codes in the plurality of multi-character alphanumeric codes reaches a predetermined code number limit (650).

In some embodiments, the candidate multi-character alphanumeric code extends the amount of time that the second device, or one or more services hosted by the second device, is operable in an active state (652). In various implementations, the candidate multi-character alphanumeric code is associated with a rent-to-own plan for the second device (e.g., 654), or is associated with a continuous rental plan for the second device (e.g., 656). In some embodiments, the candidate multi-character alphanumeric code consists of 10, 11 or 12 digits (e.g., 658).

In some implementations, the first device and the second device are the same (660). In some implementations, the first device and the second device do not have access to a cellular network (662).

The second device is configured to power a plurality of devices in electrical communication with the second device when the device is in the active state (664).

The one or more processors may be master processors and, in such embodiments, a device in the plurality of devices includes a slave processor responsive to instructions from a master processor to regulate between the active (e.g., powered) state and the inactive (e.g., unpowered) state of the second device (666). In various implementations, the second device does not include a SIM card or access to a cellular network (668).

In some embodiments, the second device includes a rechargeable battery and a plurality of power ports, and each respective power port in the plurality of power ports in electrical communication with the battery and is configured to power an apparatus when the second device is in the usable state (670). Examples of the apparatus include, but are not limited to a light, a mobile telephone, a radio, a laptop computer, a tablet computer, etc. (672). In some embodiments, the second device includes an energy capture device that is in electrical communication with the rechargeable battery (674) and the energy capture device is a solar panel (676).

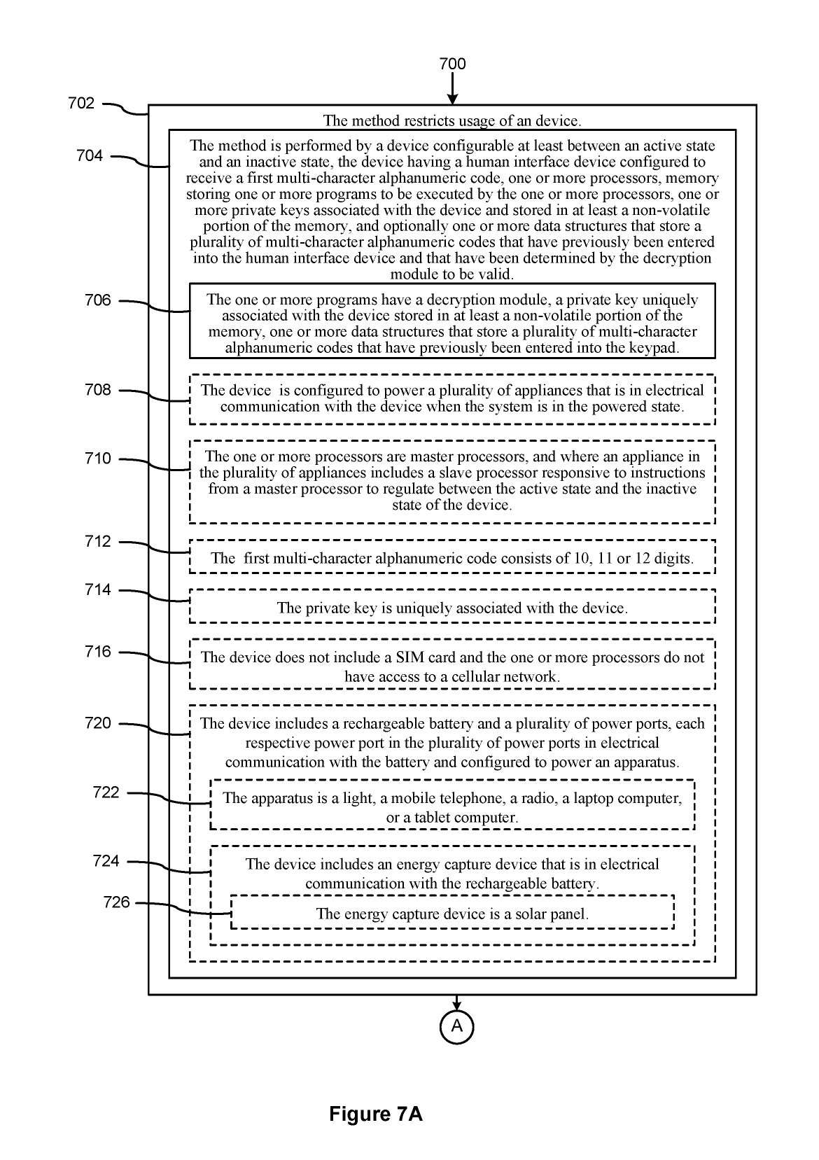

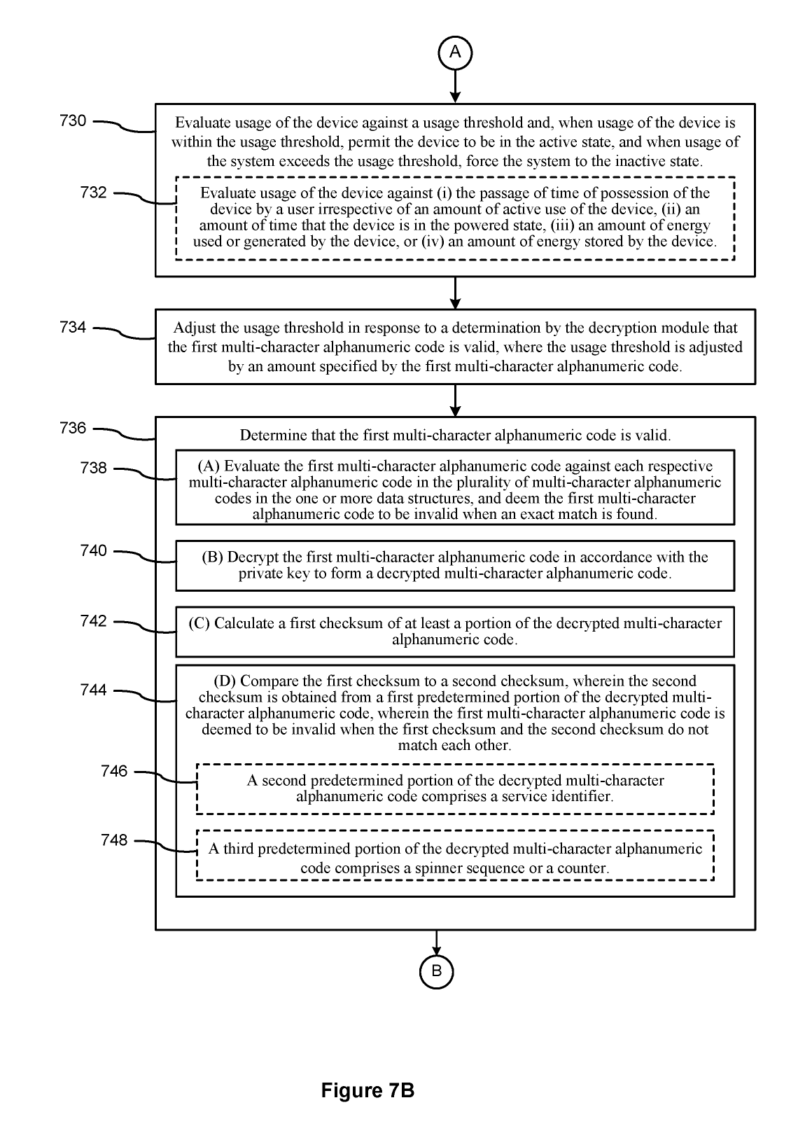

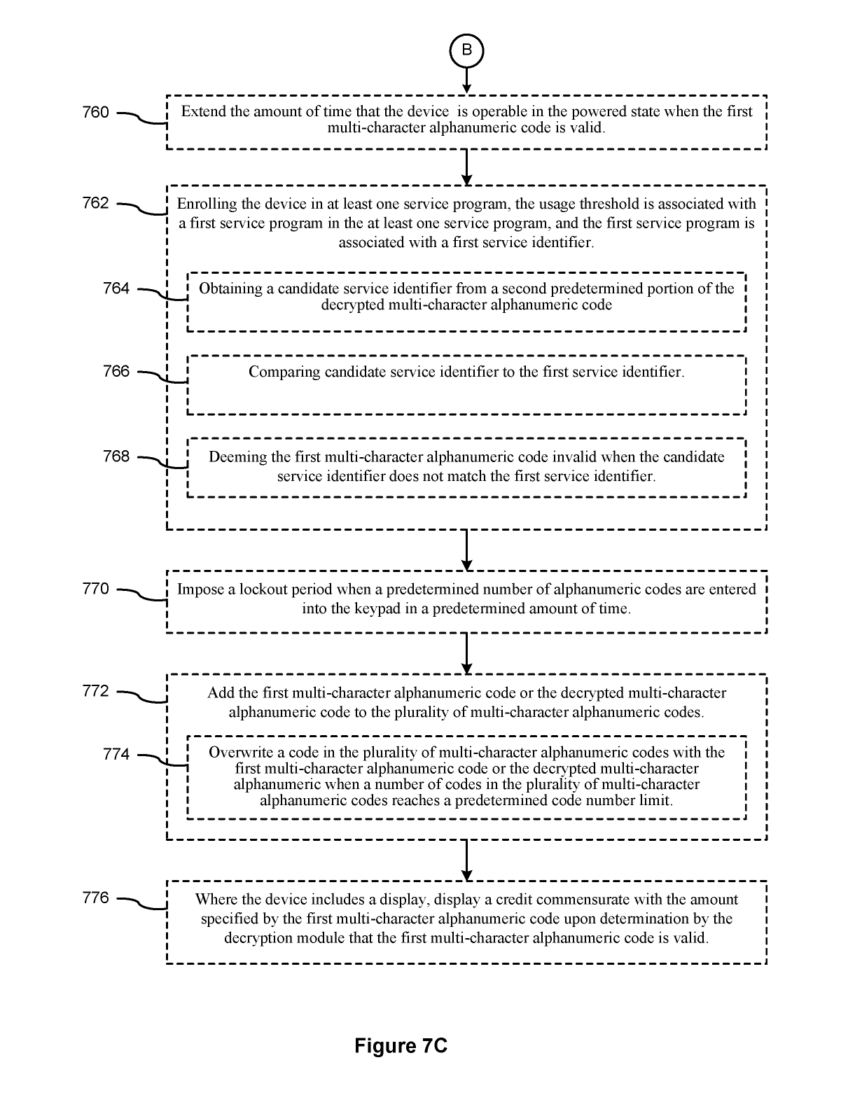

FIGS. 7A-7C are a flow diagram 700 depicting an example method 702 of restricting usage of a device. The device is configurable at least between an active state and an inactive state and has a human interface device configured to receive a first multi-character alphanumeric code, one or more processors, memory storing one or more programs, a private key associated with the device and stored in at least a non-volatile portion of the memory, and optionally one or more data structures that store a plurality of multi-character alphanumeric codes that have previously been entered into the human interface device and that have been determined by the decryption module to be valid is provided (704). The one or more programs have a decryption module, a private key uniquely associated with the device stored in at least a non-volatile portion of the memory, and one or more data structures that store a plurality of multi-character alphanumeric codes that have previously been entered into the human interface device (706).

In some embodiments, the device is configured to power a plurality of appliances that are in electrical communication with the device when the device is in the active state (708).

In some embodiments, the one or more processors are master processors, and an apparatus in the plurality of apparatus includes a slave processor responsive to instructions from the master processor to regulate between the active state and the inactive state of the device (710).

In some embodiments, the first multi-character alphanumeric code consists of 10, 11 or 12 digits (712). In some embodiments, the private key is uniquely associated with the device (e.g., 714).

In some embodiments, the device optionally does not include a SIM card and the one or more processors do not have access to a cellular network (716).

In some embodiments, the device includes a rechargeable battery and a plurality of power ports, each respective power port in the plurality of power ports in electrical communication with the battery and configured to power an apparatus (720). In some embodiments, a powered apparatus is a light, a mobile telephone, a radio, a laptop computer, or a tablet computer (722). In some embodiments, the device includes an energy capture device that is in electrical communication with the rechargeable battery (724). In some embodiments, the energy capture device is a solar panel (726).

Usage of the device, or services offered by the device, is evaluated against usage thresholds and, when usage of the device, or a service offered by the device, is within the usage threshold, the device is permitted to be in the active state, and when usage of the device, or a service provided by the device, exceeds the usage threshold, the device is forced to an inactive state (730). Usage of the device is evaluated against (i) the passage of time of possession of the system by a user irrespective of an amount of active use of the device, (ii) an amount of time that the device is in the active state, (iii) an amount of energy used or generated by the device, or (iv) an amount of energy stored by the device (732).

In some embodiments, the usage threshold is adjusted in response to a determination by the decryption module that the first multi-character alphanumeric code is valid, where the usage threshold is adjusted by an amount specified by the first multi-character alphanumeric code (734).

In some embodiments, a determination is made as to whether the first multi-character alphanumeric code is valid (736). In some such embodiments, the first multi-character alphanumeric code is evaluated against each respective multi-character alphanumeric code in the plurality of multi-character alphanumeric codes in the one or more data structures (738). The first multi-character alphanumeric code is deemed to be invalid when an exact match is found. In some embodiments, such a comparison is not done.

The first multi-character alphanumeric code is decrypted in accordance with the private key to form a decrypted multi-character alphanumeric code (740). In some embodiments, a first checksum of at least a portion of the decrypted multi-character alphanumeric code is calculated (742). The first checksum is compared to a second checksum. The second checksum is obtained from a first predetermined portion of the decrypted multi-character alphanumeric code. The first multi-character alphanumeric code is deemed to be invalid when the first checksum and the second checksum do not match each other (744). Optionally, a second predetermined portion of the decrypted multi-character alphanumeric code includes a service identifier (746). Optionally, a third predetermined portion of the decrypted multi-character alphanumeric code includes a spinner sequence (748). Optionally, a third predetermined portion of the decrypted multi-character alphanumeric code includes a sequence (748).

In some implementations, the amount of time that the device, or a service provided by a device, is operable in the powered state is extended when the first multi-character alphanumeric code is valid (760).

In some implementations, the device is enrolled in at least one service program, the usage threshold is associated with a first service program in the at least one service program, and the first service program is associated with a first service identifier (762). In some embodiments, a candidate service identifier is obtained from a second predetermined portion of the decrypted multi-character alphanumeric code (764). In some embodiments, the candidate service identifier is compared to the first service identifier (766). In some embodiments, the first multi-character alphanumeric code is deemed invalid when the candidate service identifier does not match the first service identifier (768).

In some embodiments, (770) a lockout period is imposed when a predetermined number of alphanumeric codes are entered into the keypad in a predetermined amount of time.

In some embodiments, the first multi-character alphanumeric code or the decrypted multi-character alphanumeric code may be added to the plurality of multi-character alphanumeric codes (772). Optionally, a code in the plurality of multi-character alphanumeric codes is overwritten with the first multi-character alphanumeric code or the decrypted multi-character alphanumeric when a number of codes in the plurality of multi-character alphanumeric codes reaches a predetermined code number limit (774).

In some embodiments, the device optionally includes a display, a credit commensurate with the amount specified by the first multi-character alphanumeric code that is displayed upon determination by the decryption module that the first multi-character alphanumeric code is valid (776).

In light of the above description, one implementation of an exemplary device allocation system will now be described. When a destination device 102 is manufactured, installed with firmware, tested and/or updated, the destination device is assigned a unique identification, a serial number, and one or more private key (e.g., data elements 512-1, 512-2 . . . 512-n) saved in a key management system (e.g. storage 510) of the middleware server 208. The unique identification and keys will be associated in the middleware server with the serial number of the device and installed in the device's non-volatile memory. The serial number and the unique ID may be indelibly marked on the destination device in a human readable form or otherwise permanently associated with the destination device. In some embodiments, the serial number and the unique ID are the same. In some embodiments, the serial number and the unique ID are different.

The device may then be shipped to an operator where it is offered to an end user (e.g., user, customer, subscriber, household, etc.). When the user acquires the device from the operator, or their agent, the operator registers the user using the user's contact information, rate information (e.g., subscription rates, rental rates, rent-to-own rates, etc.) and the device's serial number.

In the middleware server 208, the information collected by the operator in registering a user is used to provide customer support and associate the offered rate to the destination device.

When a user makes a payment, the middleware server 208 is notified of the payment via mobile payment system 206 and/or service provider communications system 204 associating the payment with the payer's indentifying number (e.g., the payer's MSISDN), unique ID and the amount paid. One will appreciate that the payer is generally the end user, however, the payer is not necessarily the end user. Using this identifying number a particular device 102 is determined as the destination unit, currency and the rate for this payment.

Upon determining the destination device 102 and rate, an SMS message is sent to either the registered SMS number, or the SMS number making the payment, carrying the payment information encoded in an encrypted multi-character alphanumeric code (e.g., multi-character alphanumeric code). The payment information uses payment units determined by the rate associated with the product.

The middleware server 208 creates key pairs. A first key will be installed in the destination unit (e.g., stored in private key module 324 of destination device 102) and a second key associated with the destination unit stored in the middleware database (e.g., data element 512 stored in storage 510 of middleware server 208).

In some embodiments, when a payment multi-character alphanumeric code is to be generated a random value for an otherwise conventional spinner is chosen (e.g., 634) and the associated key (e.g., data element 512) is used to encrypt the payment multi-character alphanumeric code contents (e.g., 628). In some embodiments, the resulting payment multi-character alphanumeric code is then checked against the stored history of multi-character alphanumeric codes generated for the particular destination unit to the sure it has not been issued before (e.g., 638). If it is not unique, a new random spinner value is chosen and again tested. When a unique value is achieved it is stored in the history of the middleware server 208 that is associated with the particular destination unit (e.g., 648). The particular destination device 102 may have a limited number of multi-character alphanumeric codes that may be stored in its local history. When this history is filled, the destination device will start overwriting its earliest multi-character alphanumeric codes (e.g., 774). Similarly, the middleware server 208 may be configured to overwrite previously stored multi-character alphanumeric codes to increase the field of available numbers. For example, in some implementations, when the key is created, a random number between 320 and 700 could be generated and stored in both the particular destination unit and the middleware server 208. This would allow each unit to have its own rollover field of available numbers. When the history count reaches this number the oldest history entry will be overwritten by this new value. In some embodiments, rather than a spinner, a counter is used. This counter is advanced by a predetermined amount each time a different payment multi-character alphanumeric code is to be generated for a particular device. In such embodiments, it is not necessary to maintain past codes and to check them for uniqueness as in the case of the spinner embodiment. That is, the increment serves as a substitute for the spinner and the above described history mechanism, and no prior codes are stored or, at least, are not checked in the manner disclosed for the spinner embodiment.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first object could be termed a second object, and, similarly, a second object could be termed a first object, without changing the meaning of the description, so long as all occurrences of the “first object” are renamed consistently and all occurrences of the “second object” are renamed consistently. The first object and the second object are both objects, but they are not the same object.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. An electronic device that hosts one or more services, each service in the one or more services configurable between an active state and at least one inactive state, the electronic device comprising:
a human interface device configured to receive a first multi-character alphanumeric code;
one or more processors;
a memory storing one or more programs to be executed by the one or more processors;
a first private key associated with the electronic device, wherein the first private key is stored in at least a non-volatile portion of the memory;
a first unit identifier that uniquely identifies the electronic device from among a plurality of electronic devices, wherein the first unit identifier is stored in at least a non-volatile portion of the memory;
a first counter stored in the memory;
wherein the one or more programs comprise instructions for:
evaluating usage of each respective service in the one or more services against a corresponding usage threshold, wherein,
when usage of the respective service is within the corresponding usage threshold, the respective service is maintained in the active state, and
when usage of the respective service exceeds the corresponding usage threshold, the respective service is maintained in an inactive state in the at least one inactive state;
decrypting the first multi-character alphanumeric code using the first private key thereby forming a decrypted multi-character alphanumeric code, wherein the decrypted multi-character alphanumeric code comprises a unit identifier field, a counter field and a payload;
comparing the content of the unit identifier field to the first unit identifier;
comparing the content of the counter field to the first counter;
wherein, when the unit identifier field matches the first unit identifier and the counter field is within a first threshold distance of the first counter,
the payload is analyzed to adjust the usage threshold of a first service in the one more services identified by the payload by an amount specified by the payload, and
the first counter is advanced by a predetermined increment.

2. The electronic device of claim 1, wherein the payload further comprises a service field that identifies the service and the payload comprises an amount field that specifies the amount, and wherein adjustment of the corresponding usage threshold of the first service extends the amount of time that the first service is operable in the active state.

3. The electronic device of claim 1, wherein the first multi-character alphanumeric code is associated with a rent-to-own plan for the electronic device.

4. The electronic device of claim 1, wherein the first multi-character alphanumeric code is associated with a continuous rental plan for the electronic device.

5. The electronic device of claim 1, wherein the one or more services consists of a single service, and wherein the active state of the single service is a powered state of the electronic device and usage of the first service is evaluated against (i) the passage of time of possession of the electronic device by a user irrespective of an amount of active use of the electronic device, (ii) an amount of time that the single service is in the powered state, (iii) an amount of energy used or generated by the electronic device, or (iv) an amount of energy stored by the electronic device.

6. The electronic device of claim 1, wherein
the one or more services consists of a single service,
the active state of the single service is a powered state of the electronic device, and
the electronic device is configured to power a plurality of appliances that is in electrical communication with the electronic device when the electronic device is in the powered state.

7. The electronic device of claim 6, wherein the one or more processors comprises a master processor and wherein an appliance in the plurality of appliances includes a slave processor responsive to instructions from the master processor to regulate between an enabled state and a disabled state.

8. The electronic device of claim 1, wherein the electronic device does not include a SIM card does not have access to a cellular network.

9. The electronic device of claim 1, further comprising a display, and wherein the one or more programs further comprise instructions for displaying a credit commensurate with the amount specified by the payload upon determination that the unit identifier field matches the first unit identifier and the counter field is within the first threshold distance of the first counter.

10. The electronic device of claim 1, wherein the device further comprises:
a rechargeable battery, and
a plurality of power ports, each respective power port in the plurality of power ports in electrical communication with the battery and configured to power an apparatus when the first service is in the active state and configured to not power an apparatus when the first service is in an inactive state.

11. The electronic device of claim 10, wherein the apparatus is a light, a mobile telephone, a smart phone, a radio, a laptop computer, or a tablet computer.

12. The electronic device of claim 10, wherein the electronic device further comprises:
an energy capture device that is in electrical communication with the rechargeable battery.

13. The electronic device of claim 1, wherein the electronic device stores a plurality of private keys and wherein the one or more programs selects a new first private key from among the plurality of private keys in response to a reset.

14. The electronic device of claim 13, wherein the reset is a predetermined keypad sequence entered at the human interface device, wherein the predetermined keypad sequence is also stored in a nonvolatile portion of the memory.

15. The electronic device of claim 1, wherein the first counter is an integer that represents a number of multi-character alphanumeric codes entered at the human interface device.

16. The electronic device of claim 1, wherein, when the counter field is outside a second threshold distance of the first counter, the first key is no longer used to decrypt alphanumeric codes entered at the human interface device.

17. The electronic device of claim 1, wherein the one or more services comprises a plurality of services.

18. A server comprising:
one or more processors;
a plurality of data elements, wherein each respective data element in the plurality of data elements is for a corresponding device in a plurality of device, and wherein each respective data element in the plurality of data elements comprises a unique identifier, a unique serial number, and a private key that are each uniquely associated with the corresponding device;
memory storing one or more programs to be executed by the one or more processors, the one or more programs comprising instructions for:
receiving a registration request for a first device in the plurality of devices from a first origination, wherein the registration request includes a serial number and a mobile station international subscriber directory number (MSISDN) for an entity in possession of the first device, wherein the first device is not addressable by the MSISDN and wherein the registration request is associated with rate information for the first device;
storing the MSISDN and rate information for the first device in the data element associated with the first device when the serial number in the registration request matches the serial number in the data element;
receiving a payment message from a second origination, wherein the payment message comprises an MSISDN number, a unique identifier, and an amount paid;
using the unique identifier to identify the first device in the plurality of device, whereupon identification of the first device, the one or more programs further comprise instructions for:
(A) forming a multi-character alphanumeric code comprising a first portion, a second portion and a third portion, wherein
the first portion identifies an amount of a service in accordance with the payment message,
the second portion comprises the serial number of the first device, and
the third portion comprises a first counter associated with the first device;
(B) encrypting the multi-character alphanumeric code using a key uniquely associated with the first device thereby forming an encrypted multi-character alphanumeric code;
(C) communicating the encrypted multi-character alphanumeric code to an MSISDN number associated with the first device thereby enabling a user associated with the first device to maintain a first service run by the first device in an active state; and
(D) advancing the first counter associated with the first device by an increment.

19. A destination device configurable between an active state and an inactive state, the destination device comprising:
a human interface device configured to receive a first multi-character alphanumeric code;
one or more processors;
a memory storing one or more programs to be executed by the one or more processors;
a first private key associated with the electronic device, wherein the first private key is stored in at least a non-volatile portion of the memory;
a first unit identifier that uniquely identifies the electronic device from among a plurality of electronic devices, wherein the first unit identifier is stored in at least a non-volatile portion of the memory;
a first counter stored in the memory;
wherein the one or more programs comprise instructions for:
evaluating usage of the destination device against a usage threshold, wherein,
when usage of the destination device is within the usage threshold, the destination device is maintained in the active state, and
when usage of the destination device exceeds the usage threshold, the destination device is maintained in the inactive state;
decrypting the first multi-character alphanumeric code using the first private key thereby forming a decrypted multi-character alphanumeric code, wherein the decrypted multi-character alphanumeric code comprises a unit identifier field, a counter field and a payload;
comparing the content of the unit identifier field to the first unit identifier;
comparing the content of the counter field to the first counter;
wherein, when the unit identifier field matches the first unit identifier and the counter field is within a first threshold distance of the first counter,
the multi-character alphanumeric code is analyzed to adjust the usage threshold by an amount specified by the payload, and
the first counter is advanced by a predetermined increment.
